(19) United States
(12) Patent Application Publication
(10) Pub. No.: US 2025/0289952 A1
(43) Pub. Date: Sep. 18, 2025

(54) ONE-COMPONENT THERMOSETTING RESIN COMPOSITION AND UTILIZATION THEREOF

(71) Applicant: KANEKA CORPORATION, Osaka (JP)

(72) Inventor: Toshihiko Okamoto, Hyogo (JP)

(73) Assignee: KANEKA CORPORATION, Osaka (JP)

(21) Appl. No.: 19/226,651

(22) Filed: Jun. 3, 2025

Related U.S. Application Data
(63) Continuation of application No. PCT/JP2023/043983, filed on Dec. 8, 2023.

(30) Foreign Application Priority Data
Dec. 9, 2022 (JP) 2022-197458

(51) Int. Cl. C08L 63/00; C08G 59/18; C08G 59/24; C08G 59/40; C08J 3/20; C08K 3/22; C08K 3/26; C08K 3/36; C09J 163/00

(52) U.S. Cl. CPC C08L 63/00; C08G 59/184; C08G 59/245; C08G 59/4021; C08J 3/203; C08K 3/26; C08K 3/36; C09J 163/00; C08J 2363/02; C08J 2409/00; C08J 2433/08; C08K 2003/2206; C08K 2003/265; C08L 2205/22; C08L 2207/53

(57) ABSTRACT

A one-component type thermosetting resin composition that makes it possible to provide a cured product having excellent adhesive strength by low-temperature curing and that has excellent storage stability is provided. The one-component type thermosetting resin composition contains an epoxy resin, polymer particles, dicyandiamide, and an amine adduct curing agent each in specific amounts. The one-component type thermosetting resin composition has a specific exothermic onset temperature and a specific exothermic peak temperature. In addition, the one-component type thermosetting resin composition has a specific amount of urea compound, has a specific amount of epoxy-based reactive diluent, or has a specific amount of epoxy group in a shell layer of the polymer particles.

### TECHNICAL FIELD

One or more embodiments of the present invention relate to a one-component type thermosetting resin composition and a use thereof.

### BACKGROUND ART

A thermosetting resin composition containing an epoxy resin has been used in a wide variety of fields, as in Patent Literatures 1 to 4. For example, such a thermosetting resin composition is disclosed as a structural adhesive agent in Patent Literature 1 or Patent Literature 3.

Currently, in the field of structural adhesive agents, low-temperature curing has been required from the viewpoint of carbon neutrality efforts. In addition, conventionally, adhesion properties and storage stability for adhesive agents tend to be required.

### PATENT LITERATURE

### [Patent Literature 1]

Publication of Japanese Patent No. 6955661

### [Patent Literature 2]

Japanese Patent Application Publication Tokukai No. 2015-54940

### [Patent Literature 3]

Publication of Japanese Patent No. 7109164

### [Patent Literature 4]

Japanese Patent Application Publication, Tokukai, No. 2018-80310

The conventional thermosetting resin compositions are not sufficient from the viewpoint of adhesion properties of cured products obtained by subjecting the conventional thermosetting resin compositions to low-temperature curing and/or storage stability of thermosetting resin compositions in a case where the conventional thermosetting resin compositions are used as one-pack (one-component) type thermosetting resin compositions, and have room for further improvements.

In view of the current circumstances as described above, one or more embodiments of the present invention have been attained. one or more embodiments of the present invention are to provide a novel one-component type thermosetting resin composition that makes it possible to provide a cured product having excellent adhesive strength by low-temperature curing and that has excellent storage stability.

### SUMMARY

As a result of conducting diligent study in order to attain the above, the inventors of one or more embodiments of the present invention have completed one or more embodiments of the present invention.

That is, a one-component type thermosetting resin composition in accordance with one or more embodiments of the present invention includes: an epoxy resin (A); polymer particles (B) in an amount of 1 part by mass to 100 parts by mass with respect to 100 parts by mass of the epoxy resin (A), the polymer particles (B) having a core-shell structure which includes a core layer and a shell layer; dicyandiamide (C) in an amount of 3.5 parts by mass to 19.0 parts by mass with respect to 100 parts by mass of the epoxy resin (A); and an amine adduct curing agent (D) in an amount of 0.3 parts by mass to 10.0 parts by mass with respect to 100 parts by mass of the epoxy resin (A), the amine adduct curing agent (D) being solid at room temperature, wherein the one-component type thermosetting resin composition has an exothermic onset temperature of not lower than 80° C. and an exothermic peak temperature of not higher than 150° C. in a DSC curve of the one-component type thermosetting resin composition as measured with use of a differential scanning calorimeter under a condition that a temperature increase rate is 10° C./min, and the one-component type thermosetting resin composition satisfies at least one selected from the group consisting of the following items (1) to (3):

(1) the one-component type thermosetting resin composition further comprises, in an amount of 0.5 parts by mass to 15.0 parts by mass, a urea compound (E) represented by general formula (X):

R¹—NH—C(═O)—N—R²₂ (X)
where R¹ is a substituted or unsubstituted hydrocarbon group having 1 to 20 carbon atoms, and two R² are each independently a substituted or unsubstituted hydrocarbon group having 1 to 20 carbon atoms,
a ratio (Wc/We) of a total mass Wc of the dicyandiamide (C) to a total mass We of the urea compound (E) is 1.1 to 20.0, and
a ratio (We/Wd) of the total mass We of the urea compound (E) to a total mass Wd of the amine adduct curing agent (D) is 1.1 to 20.0;
(2) the one-component type thermosetting resin composition further comprises an epoxy-based reactive diluent (F) in an amount of 1.0 part by mass to 20.0 parts by mass; and
(3) the shell layer of the polymer particles (B) has an epoxy group, and a contained amount of the epoxy group in the shell layer with respect to a total mass of the shell layer is more than 0 mmol/g and not more than 2.0 mmol/g.

### Advantageous Effects of Invention

According to one or more embodiments of the present invention, it is possible to provide a novel one-component type thermosetting resin composition that makes it possible to provide a cured product having excellent adhesive strength by low-temperature curing and that has excellent storage stability.

### DETAILED DESCRIPTION

The following description will discuss embodiments of the present invention. The present invention is not, however, limited to these embodiments. The present invention is not limited to the configurations described below, but may be altered in various ways within the scope of the claims. Any embodiment or Example derived by combining technical means disclosed in differing embodiments and Examples is also encompassed in the technical scope of the present invention. All academic and patent documents cited in the present specification are incorporated herein by reference. Unless otherwise specified in the present specification, any numerical range expressed as “A to B” intends to means “not less than A and not more than B”.

### [1. Curable Resin Composition]

A one-component type thermosetting resin composition in accordance with one or more embodiments of the present invention contains: an epoxy resin (A); polymer particles (B) in an amount of 1 part by mass to 100 parts by mass with respect to 100 parts by mass of the epoxy resin (A), the polymer particles (B) having a core-shell structure which includes a core layer and a shell layer; dicyandiamide (C) in an amount of 3.5 parts by mass to 19.0 parts by mass with respect to 100 parts by mass of the epoxy resin (A); and an amine adduct curing agent (D) in an amount of 0.3 parts by mass to 10.0 parts by mass with respect to 100 parts by mass of the epoxy resin (A), the amine adduct curing agent (D) being solid at room temperature, wherein the one-component type thermosetting resin composition has an exothermic onset temperature of not lower than 80° C. and an exothermic peak temperature of not higher than 150° C. in a DSC curve of the one-component type thermosetting resin composition as measured with use of a differential scanning calorimeter under a condition that a temperature increase rate is 10° C./min, and the one-component type thermosetting resin composition satisfies at least one selected from the group consisting of the following items (1) to (3):
(1) the one-component type thermosetting resin composition further contains, in an amount of 0.5 parts by mass to 15.0 parts by mass, a urea compound (E) represented by general formula (X):

R¹—NH—C(═O)—N—R²₂ (X),
where R¹ is a substituted or unsubstituted hydrocarbon group having 1 to 20 carbon atoms, and two R² are each independently a substituted or unsubstituted hydrocarbon group having 1 to 20 carbon atoms,
a ratio (Wc/We) of a total mass Wc of the dicyandiamide (C) to a total mass We of the urea compound (E) is 1.1 to 20.0, and
a ratio (We/Wd) of the total mass We of the urea compound (E) to a total mass Wd of the amine adduct curing agent (D) is 1.1 to 20.0;
(2) the one-component type thermosetting resin composition further contains an epoxy-based reactive diluent (F) in an amount of 1.0 part by mass to 20.0 parts by mass; and
(3) the shell layer of the polymer particles (B) has an epoxy group, and a contained amount of the epoxy group in the shell layer with respect to a total mass of the shell layer is more than 0 mmol/g and not more than 2.0 mmol/g.

In the present specification, the “epoxy resin (A)”, the “polymer particles (B)”, the “dicyandiamide (C)”, the “amine adduct curing agent (D)”, the “urea compound (E)”, and the “epoxy-based reactive diluent (F)” may also be referred to as “component (A)”, “component (B)”, “component (C)”, “component (D)”, “component (E)”, and “component (F)”, respectively. Further, in the present specification, the “one-component type thermosetting resin composition” may be referred to as “composition”, and the “one-component type thermosetting resin composition in accordance with one or more embodiments of the present invention” may be referred to as “the present composition”.

The present composition may be a composition that satisfies only the item (1), may be a composition that satisfies only the item (2), may be a composition that satisfies only the item (3), may be a composition that satisfies only the items (1) and (2), may be a composition that satisfies only the items (1) and (3), may be a composition that satisfies only the items (2) and (3), or may be a composition that satisfies all of the following items: the item (1); the item (2); and the item (3). In the present specification, among the one-component type thermosetting resin compositions in accordance with one or more embodiments of the present invention, the “one-component type thermosetting resin composition that satisfies the item (1)” may be referred to as “one-component type thermosetting resin composition (I) in accordance with one or more embodiments of the present invention” or “composition (I)”, the “one-component type thermosetting resin composition that satisfies the item (2)” may be referred to as “one-component type thermosetting resin composition (II) in accordance with one or more embodiments of the present invention” or “composition (II)”, and the “one-component type thermosetting resin composition that satisfies the item (3)” may be referred to as “one-component type thermosetting resin composition (III) in accordance with one or more embodiments of the present invention” or “composition (III)”. In the present specification, among the one-component type thermosetting resin compositions in accordance with one or more embodiments of the present invention, the “one-component type thermosetting resin composition that satisfies the items (1) and (2)” may be referred to as “one-component type thermosetting resin composition (I)+(II) in accordance with one or more embodiments of the present invention” or “composition (I)+(II)”, the “one-component type thermosetting resin composition that satisfies the items (1) and (3)” may be referred to as “one-component type thermosetting resin composition (I)+(III) in accordance with one or more embodiments of the present invention” or “composition (I)+(III)”, the “one-component type thermosetting resin composition that satisfies the items (2) and (3)” may be referred to as “one-component type thermosetting resin composition (II)+(III) in accordance with one or more embodiments of the present invention” or “composition (II)+(III)”, and the “one-component type thermosetting resin composition that satisfies all of the following items: the item (1); the item (2); and the item (3)” may be referred to as “one-component type thermosetting resin composition (I)+(II)+(III) in accordance with one or more embodiments of the present invention” or “composition (I)+(II)+(III)”. The present composition encompasses the composition (I), the composition (II), the composition (III), the composition (I)+(II), the composition (I)+(III), the composition (II)+(III), and the composition (I)+(II)+(III).

The present composition has the above-described feature and thus has an advantage of making it possible to provide a cured product having excellent adhesive strength by low-temperature curing and an advantage of having excellent storage stability.

Note that, in the present specification, “making it possible to provide a cured product having excellent adhesive strength by low-temperature curing” and “a cured product has excellent adhesive strength” are intended to mean that a cured product obtained by curing a composition at a low temperature (for example, 120° C.) for, for example, a curing time of 20 minutes has a high shear adhesive strength (for example, not less than 7 MPa). A method for measuring the shear adhesive strength of a cured product will be described in detail in Examples later.

It can be said that the higher the shear adhesive strength of a cured product, the more excellent the adhesive strength of the cured product. In one or more embodiments of the present invention, the adhesive strength of a cured product obtained by subjecting the present composition to low-temperature curing may be not less than 7 MPa, not less than 11 MPa, or not less than 15 MPa.

In addition, in the present specification, “excellent storage stability” is intended to mean, for example, that, when a composition has been stored (left to stand) under a predetermined condition, the composition does not gelatinize after the storage. Examples of the condition for storing the composition (leaving the composition to stand) encompass a case where the composition is stored (left to stand) at 40° C. for 14 days.

In one or more embodiments of the present invention, the storage stability of a composition can also be evaluated on the basis of a ratio, when the composition has been stored (left to stand) under a predetermined condition, of the viscosity of the composition after the storage to the viscosity of the composition before the storage (viscosity of the composition after storage/viscosity of the composition before storage). In the present specification, the “viscosity of the composition after storage/viscosity of the composition before storage” may also be referred to as “viscosity increase rate after storage”. In one or more embodiments of the present invention, for example, when the composition has been stored (left to stand) at 40° C. for 14 days, the viscosity increase rate after the storage may be 0.5 to 20.0, 0.5 to 15.0, 0.5 to 13.0, 0.6 to 10.0, 0.6 to 9.0, 0.7 to 4.0, or 0.8 to 2.0.

The present composition makes it possible to provide a cured product having excellent adhesive strength by low-temperature curing and thus makes it possible to reduce the amount of energy required for curing of the composition and reduce the production cost. Such an effect also contributes to achievement of, for example, Goal 7 “Ensure access to affordable, reliable, sustainable and modern energy for all” of the Sustainable Development Goals (SDGs) proposed by the United Nations. In addition, the present composition also has an advantage of making it possible to reduce the amount of carbon dioxide emissions caused by the curing of the composition and making it possible to reduce greenhouse gases. Such an effect also contributes to achievement of, for example, Goal 13 “Take urgent action to combat climate change and its impacts” and other goal proposed by the United Nations.

The inventor of one or more embodiments of the present invention has conducted diligent studies for the purpose of providing a one-component type thermosetting resin composition that makes it possible to provide a cured product having excellent adhesive strength by low-temperature curing and that has excellent storage stability. As a result, the inventor has obtained, on his own, a novel finding that, surprisingly, one or more compositions selected from the group consisting of the composition (I), the composition (II), the composition (III), the composition (I)+(II), the composition (I)+(III), the composition (II)+(III), and the composition (I)+(II)+(III) which have been described above make it possible to provide a cured product having excellent adhesive strength by low-temperature curing and have excellent storage stability, and the inventor of one or more embodiments of the present invention has completed one or more embodiments of the present invention.

For example, in the composition (I), three components that are dicyandiamide (C), an amine adduct curing agent (D), and a urea compound (E) all of which can contribute to a curing reaction are contained in combination, and a contained amount of each of the components is set to fall within a specific range. This allows the composition (I) to have an advantage of making it possible to provide a cured product having excellent adhesive strength by low-temperature curing and an advantage of having excellent storage stability. In the course of diligent studies, the inventor of one or more embodiments of the present invention has obtained, on his own, a finding that a composition containing only any two components of the following components: the component (C); the component (D); and the component (E) in a case where the composition contains the component (F) or in a case where the shell layer does not contain a specific amount of epoxy group cannot achieve both excellent adhesive strength of a cured product obtained by low-temperature curing and excellent storage stability.

Further, in the composition (II), an epoxy-based reactive diluent (F) is contained in addition to the use of dicyandiamide (C) and an amine adduct curing agent (D), and a contained amount of each of the components is set to fall within a specific range. This allows the composition (II) to have an advantage of making it possible to provide a cured product having excellent adhesive strength by low-temperature curing and an advantage of having excellent storage stability. The reason why the composition having the above-described advantages is obtained by containing the following three components: dicyandiamide (C); an amine adduct curing agent (D); and an epoxy-based reactive diluent (F) is unclear, but, from the obtained result, the inventor of one or more embodiments of the present invention infers that containing the epoxy-based reactive diluent (F) improves flexibility of a resulting cured product and thus improves the adhesive strength of the cured product. Note that one or more embodiments of the present invention are not limited by such inference.

A composition in accordance with one or more embodiments of the present invention may be (i) the composition (I) and the composition (II), i.e. the composition (I)+(II), (ii) the composition (I) and the composition (III), i.e. the composition (I)+(III), (iii) the composition (II) and the composition (III), i.e. the composition (II)+(III), or (iv) the composition (I), the composition (II), and the composition (III), i.e. the composition (I)+(II)+(III). In other words, a composition in accordance with one or more embodiments of the present invention may be (i) a composition that satisfies both the condition for the composition (I) and the condition for the composition (II), i.e. a composition that satisfies both the item (1) and the item (2), (ii) a composition that satisfies both the condition for the composition (I) and the condition for the composition (III), i.e. a composition that satisfies both the item (1) and the item (3), (iii) a composition that satisfies both the condition for the composition (II) and the condition for the composition (III), i.e. a composition that satisfies both the item (2) and the item (3), or (iv) a composition that satisfies all of the following conditions: the condition for the composition (I); the condition for the composition (II); and the condition for the composition (III), i.e. a composition that satisfies all of the following items: the item (1); the item (2); and the item (3).

### <Epoxy Resin (A)>

Various types of epoxy resins can be used as the epoxy resin (A).

Examples of the epoxy resins encompass bisphenol A epoxy resin, bisphenol F epoxy resin, bisphenol AD epoxy resin, bisphenol S epoxy resin, glycidyl ester type epoxy resin, glycidyl amine type epoxy resin, novolac type epoxy resin, glycidyl ether type epoxy resin of bisphenol A propylene oxide adduct, hydrogenated bisphenol A (or F) epoxy resin, fluorinated epoxy resin, flame-resistant epoxy resin such as glycidyl ether of tetrabromo bisphenol A, p-oxybenzoic acid glycidyl ether ester type epoxy resin, m-aminophenol type epoxy resin, diaminodiphenylmethane-based epoxy resin, various types of alicyclic epoxy resins, N,N-diglycidyl aniline, N,N-diglycidyl-o-toluidine, triglycidyl isocyanurate, divinylbenzene dioxide, resorcinol diglycidyl ether, chelate-modified epoxy resin, rubber-modified epoxy resin, urethane-modified epoxy resin, hydantoin-type epoxy resin, an epoxidized product of an unsaturated polymer such as petroleum resin, amino-containing glycidyl ether resin, and an epoxy compound obtained by causing an addition reaction between one of the above epoxy resins and e.g. a bisphenol A (or F) or a polybasic acid.

Examples of the epoxy compound obtained by causing an addition reaction between one of the above epoxy resins and a polybasic acid or the like encompass an addition reaction product of (i) a dimer (dimer acid) of a tall oil fatty acid and (ii) bisphenol A epoxy resin, such as that disclosed in International Publication No. WO 2010/098950.

The epoxy resin (A) is not limited to these examples, and a generally used epoxy resin can be used. These examples of the epoxy resin (A) may be used alone, or two or more of these examples of the epoxy resins (A) may be used in combination.

Here, in the present specification, polyalkylene glycol diglycidyl ether, glycol diglycidyl ether, diglycidyl ester of aliphatic polybasic acid, glycidyl ether of a polyvalent aliphatic alcohol having bivalency or greater valency, and monoepoxide are not included in the epoxy resin (A). These resins, i.e. polyalkylene glycol diglycidyl ether, glycol diglycidyl ether, diglycidyl ester of aliphatic polybasic acid, glycidyl ether of a polyvalent aliphatic alcohol having bivalency or greater valency, and monoepoxide, have a relatively low viscosity (for example, not more than 500 mPa-s at 25° C.) as compared with the epoxy resins described above. In other words, in the present specification, epoxy resins having a viscosity of not more than 500 mPa-s at 25° C. are not included in the epoxy resin (A).

The rubber-modified epoxy resin may be a reaction product that has been obtained by reacting rubber with an epoxy group-containing compound and that contains 1.1 or more epoxy groups, or two or more epoxy groups, on average per molecule. As the rubber-modified epoxy resin, for example, the resins described in paragraphs [0124] to [0132] in the pamphlet of WO 2016/163491 can be used.

As the chelate-modified epoxy resin, for example, the resins described in paragraphs [0018] to [0019] in the pamphlet of WO 2016/163491 can be used.

As the urethane-modified epoxy resin, for example, the resins described in paragraphs [0133] to [0135] in the pamphlet of WO 2016/163491 can be used.

Among these epoxy resins, epoxy resins each having at least two epoxy groups in one molecule are preferable in that, for example, such resins have high curability, allow a cured product to be rich in flexibility, and bring about an excellent effect of enhancing impact-peel resistance of a cured product when the polymer particles (B) are blended therewith. Particularly preferable is a compound having two epoxy groups in one molecule.

Among the abovementioned epoxy resins, bisphenol A epoxy resin and bisphenol F epoxy resin are relatively inexpensive and make it possible to obtain a cured product which has a high elastic modulus, excellent heat resistance, and excellent adhesiveness. Thus, the epoxy resin (A) may contain bisphenol A epoxy resin and/or bisphenol F epoxy resin, or that the epoxy resin (A) may be (consist only of) bisphenol A epoxy resin and/or bisphenol F epoxy resin. In addition, the epoxy resin (A) may contain bisphenol A epoxy resin, or that the epoxy resin (A) may be (consist only of) bisphenol A epoxy resin, because a curable resin composition that makes it possible to provide a cured product which has excellent heat resistance can be obtained at a low cost.

The epoxy resin (A) may have an epoxy equivalent weight of less than 220 g/eq, not less than 90 g/eq but less than 210 g/eq, or not less than 135 g/eq but less than 200 g/eq. Such a configuration has an advantage of making it possible to obtain a cured product having a high elastic modulus and high heat resistance.

In the present specification, the epoxy equivalent weight is intended to mean a molecular weight per epoxy group that is contained in a compound having an epoxy group, and is specifically a value obtained by calculation based on the following expression: Epoxy equivalent weight (g/eq)=mass average molecular weight (Mw) of compound/number of epoxy groups per molecule of compound (average number).

Note that the epoxy equivalent weight can also be measured in accordance with JIS K 7236.

Both bisphenol A epoxy resin having an epoxy equivalent weight of less than 220 g/eq and bisphenol F epoxy resin having an epoxy equivalent weight of less than 220 g/eq are liquid at normal temperature. Therefore, the epoxy resin (A) may contain bisphenol A epoxy resin having an epoxy equivalent weight of less than 220 g/eq and/or bisphenol F epoxy resin having an epoxy equivalent weight of less than 220 g/eq. Such a configuration has an advantage of allowing a resulting composition to have further excellent storage stability.

A total contained amount of bisphenol A epoxy resin having an epoxy equivalent weight of less than 220 g/eq and/or bisphenol F epoxy resin having an epoxy equivalent weight of less than 220 g/eq in the epoxy resin (A) may be not less than 60% by mass, not less than 80% by mass, or not less than 90% by mass, in 100% by mass of the epoxy resin (A). Such a configuration has an advantage of allowing a resulting cured product to have more excellent impact resistance. The total contained amount of bisphenol A epoxy resin having an epoxy equivalent weight of less than 220 g/eq and/or bisphenol F epoxy resin having an epoxy equivalent weight of less than 220 g/eq in the epoxy resin (A) may be 100% by mass in 100% by mass of the epoxy resin (A). In other words, the epoxy resin (A) may be (consist only of) bisphenol A epoxy resin having an epoxy equivalent weight of less than 220 g/eq and/or bisphenol F epoxy resin having an epoxy equivalent weight of less than 220 g/eq.

### <Polymer Particles (B)>

The polymer particles (B) can exhibit a toughness improvement effect in the present composition. In other words, by containing the component (B), the present composition has an advantage of making it possible to provide a cured product (for example, an adhesive layer) that has excellent impact-peel-resistant adhesiveness. In addition, in a case where the present composition contains the component (B), a resulting cured product tends to have excellent adhesive strength. Since the polymer particles (B) have a core-shell structure, the polymer particles (B) may also be referred to as “core-shell polymer particles (B)”.

Although the structure of the polymer particles (B) is not particularly limited, the polymer particles (B) may have a structure having two or more layers in total, the structure including at least a core layer and a shell layer. The polymer particles (B) may have a structure having three or more layers, the structure including a core layer, an intermediate layer covering the core layer, and a shell layer covering the intermediate layer. The polymer particles (B) may be core-shell polymer particles in which the shell layer is formed by graft polymerizing a graft copolymerizable monomer (monomer for shell layer formation) in the presence of the core polymer. This polymerization operation can be carried out by adding a monomer for shell layer formation to core polymer latex that is prepared and exists in the form of an aqueous polymer latex, and then carrying out polymerization. The polymer particles (B) can have a structure that includes a core layer which is present inside the particle and at least one shell layer which is graft polymerized to the surface of the core layer and which entirely or partially covers the core layer. In the polymer particles (B), a shell polymer and a core polymer may be substantially chemically bonded to each other. Note that the core layer and the shell layer may not form a complete layer structure. The shell polymer only needs to cover at least part of the core layer and may not cover the whole of the core layer. In addition, part of the shell polymer may enter the core layer.

The following description will discuss each layer of the polymer particles (B) specifically.

### <<Core Layer>>

The core layer may be an elastic core layer that has properties as a rubber, in order to increase the toughness of a cured product of a composition.

The core layer may contain a diene-based rubber in that such a core layer (i) has a large effect of improving the toughness of a resulting cured product, (ii) has a large effect of improving the impact-peel-resistant adhesiveness of a resulting cured product, and (iii) has a low affinity with the epoxy resin (A), which makes it difficult for viscosity to increase with time due to swelling of the core layer. The core layer may contain a (meth)acrylate-based rubber in that such a core layer enables design of polymers of a wide variety of compositions by combination of a plurality of monomers. In a case where it is desirable to enhance impact resistance at low temperatures without decreasing the heat resistance of the cured product, the core layer may contain an organosiloxane-based rubber. In other words, the core layer may contain at least one type selected from the group consisting of diene-based rubbers, (meth)acrylate-based rubbers, and organosiloxane-based rubbers.

### (Diene-Based Rubber)

The diene-based rubber may be a polymer that contains a structural unit derived from at least one monomer selected from the group consisting of conjugated diene-based monomers (hereinafter also referred to as conjugated diene-based unit) in an amount of 50% by mass to 100% by mass and a structural unit derived from a vinyl-based monomer which differs from the conjugated diene-based monomers and which is copolymerizable with the conjugated diene-based monomers in an amount of 0% by mass to 50% by mass.

Examples of the conjugated diene-based monomer encompass 1,3-butadiene, isoprene (2-methyl-1,3-butadiene), and 2-chloro-1,3-butadiene.

One type of these conjugated diene-based monomers may be used alone, or two or more types of these conjugated diene-based monomers may be used in combination.

A contained amount of the conjugated diene-based unit in the core layer may be 50% by mass to 100% by mass, 70% by mass to 100% by mass, or 90% by mass to 100% by mass, in 100% by mass of all of the structural units that constitute the core layer. Setting the contained amount of the conjugated diene-based unit in the core layer to be not less than 50% by mass makes it possible for a resulting cured product to have more favorable impact-peel-resistant adhesiveness.

Examples of the vinyl-based monomer which differs from the conjugated diene-based monomers and which is copolymerizable with the conjugated diene-based monomers encompass: vinyl arenes such as styrene, α-methylstyrene, monochlorostyrene, and dichlorostyrene; vinyl carboxylic acids such as acrylic acid and methacrylic acid; vinyl cyanides such as acrylonitrile and methacrylonitrile; halogenated vinyls such as vinyl chloride, vinyl bromide, and chloroprene; vinyl acetate; alkenes such as ethylene, propylene, butylene, and isobutylene; and polyfunctional monomers such as diallyl phthalate, triallyl cyanurate, triallyl isocyanurate, and divinylbenzene.

One type of the above-described examples of the vinyl-based monomer which differs from the conjugated diene-based monomers and which is copolymerizable with the conjugated diene-based monomers may be used alone, or two or more types of the above-described examples of the vinyl-based monomer which differs from the conjugated diene-based monomers and which is copolymerizable with the conjugated diene-based monomers may be used in combination. Among the examples of the vinyl-based monomer which differs from the conjugated diene-based monomers and which is copolymerizable with the conjugated diene-based monomers, styrene is particularly preferable.

The core layer may contain, among diene-based rubbers, butadiene rubber which is a homopolymer of 1,3-butadiene and/or butadiene-styrene rubber which is a copolymer of 1,3-butadiene and styrene, in that such a core layer (i) has a larger effect of improving the toughness of a resulting cured product, (ii) has a larger effect of improving the impact-peel-resistant adhesiveness of a resulting cured product, and (iii) has a low affinity with the epoxy resin (A), which makes it more difficult for viscosity to increase with time due to swelling of the core layer. In terms of these effects, the core layer may be (consist only of) butadiene rubber and/or butadiene-styrene rubber, the core layer may contain butadiene rubber, or that the core layer may be (consist only of) butadiene rubber. Butadiene-styrene rubber is preferable in that butadiene-styrene rubber makes it possible to increase the transparency of the resulting cured product by adjustment of a refractive index.

### ((Meth)acrylate-Based Rubber)

The (meth)acrylate-based rubber may be a polymer that is obtained by polymerizing a monomer mixture which contains a structural unit derived from at least one monomer selected from the group consisting of (meth)acrylate-based monomers (hereinafter also referred to as (meth)acrylate-based unit) in an amount of 50% by mass to 100% by mass and a structural unit derived from a vinyl-based monomer which differs from the (meth)acrylate-based monomers and which is copolymerizable with the (meth)acrylate-based monomers in an amount of 0% by mass to 50% by mass. Note that, in the present specification, “(meth)acrylate” means acrylate and/or methacrylate.

Examples of the (meth)acrylate-based monomers encompass: (i) alkyl (meth)acrylates such as methyl (meth)acrylate, ethyl (meth)acrylate, butyl (meth)acrylate, 2-ethylhexyl (meth)acrylate, octyl (meth)acrylate, dodecyl (meth)acrylate, stearyl (meth)acrylate, and behenyl (meth)acrylate; (ii) aromatic ring-containing (meth)acrylates such as phenoxyethyl (meth)acrylate and benzyl (meth)acrylate; (iii) hydroxyalkyl (meth)acrylates; (iv) glycidyl (meth)acrylates such as glycidyl (meth)acrylate and glycidyl alkyl (meth)acrylate; (v) alkoxy alkyl (meth)acrylates; (vi) allyl alkyl (meth)acrylates such as allyl (meth)acrylate and allyl alkyl (meth)acrylate; and (vii) polyfunctional (meth)acrylates such as monoethylene glycol di(meth)acrylate, triethylene glycol di(meth)acrylate, and tetraethylene glycol di(meth)acrylate.

Examples of the hydroxyalkyl (meth)acrylates encompass: hydroxy straight-chain alkyl (meth)acrylates (particularly, hydroxy straight chain C1-C6 alkyl (meth)acrylates) such as 2-hydroxyethyl (meth)acrylates, hydroxypropyl (meth)acrylates, and 4-hydroxybutyl (meth)acrylates; caprolactone-modified hydroxy (meth)acrylates; hydroxy branching alkyl (meth)acrylates such as α-(hydroxymethyl) methyl acrylates and α-(hydroxymethyl) ethyl acrylates; and hydroxyl-group-containing (meth)acrylates such as mono (meth)acrylates of a polyester diol (particularly, saturated polyester diol) obtained from a dicarboxylic acid (e.g., phthalic acid) and a dihydric alcohol (e.g., propylene glycol).

One type of these (meth)acrylate-based monomers may be used alone, or two or more types of these (meth)acrylate-based monomers may be used in combination. As the (meth)acrylate-based monomer, ethyl (meth)acrylate, butyl (meth)acrylate, and 2-ethylhexyl (meth)acrylate are preferable.

Examples of the vinyl-based monomer which differs from the (meth)acrylate-based monomers and which is copolymerizable with the (meth)acrylate-based monomers encompass: (i) vinyl arenes such as styrene, α-methylstyrene, monochlorostyrene, and dichlorostyrene; (ii) vinyl carboxylic acids such as acrylic acid and methacrylic acid; (iii) vinyl cyanides such as acrylonitrile and methacrylonitrile; (iv) halogenated vinyls such as vinyl chloride, vinyl bromide, and chloroprene; (v) vinyl acetate; (vi) alkenes such as ethylene, propylene, butylene, and isobutylene; and (vii) polyfunctional monomers such as diallyl phthalate, triallyl cyanurate, triallyl isocyanurate, and divinylbenzene.

One type of the examples of the vinyl-based monomer which differs from the (meth)acrylate-based monomers and which is copolymerizable with the (meth)acrylate-based monomers may be used alone, or two or more types of the examples of the vinyl-based monomer which differs from the (meth)acrylate-based monomers and which is copolymerizable with the (meth)acrylate-based monomers may be used in combination. Among the examples of the vinyl-based monomer which differs from the (meth)acrylate-based monomers and which is copolymerizable with the (meth)acrylate-based monomers, styrene is particularly preferable in that styrene makes it possible to easily increase a refractive index.

### (Organosiloxane-Based Rubber)

Examples of the organosiloxane-based rubber encompass: (i) organosiloxane-based polymers composed of alkyl or aryl disubstituted silyloxy units, such as dimethylsilyloxy, diethylsilyloxy, methylphenylsilyloxy, diphenylsilyloxy, and dimethylsilyloxy-diphenylsilyloxy; and (ii) organosiloxane-based polymers composed of alkyl or aryl monosubstituted silyloxy units, such as organohydrogensilyloxy in which some of sidechain alkyls have been substituted with hydrogen atoms.

One type of these organosiloxane-based rubbers may be used alone, or two or more types of these organosiloxane-based rubbers may be used in combination. Among these organosiloxane-based rubbers, dimethylsilyloxy, methylphenylsilyloxy, and dimethylsilyloxy-diphenylsilyloxy are preferable because they can provide heat resistance to a cured product, and dimethylsilyloxy is most preferable because it is easily available.

In the present specification, a polymer composed of a dimethylsilyloxy unit is referred to as a dimethylsilyloxy rubber, a polymer composed of a methylphenylsilyloxy unit is referred to as a methylphenylsilyloxy rubber, and a polymer composed of a dimethylsilyloxy unit and a diphenylsilyloxy unit is referred to as a dimethylsilyloxy-diphenylsilyloxy rubber.

The organosiloxane-based rubber may be (i) at least one type selected from the group consisting of dimethylsilyloxy rubbers, methylphenylsilyloxy rubbers, and dimethylsilyloxy-diphenylsilyloxy rubbers, because a resulting resin composition including powder can provide a formed body which has excellent heat resistance or a cured product which has excellent heat resistance, or may be (ii) a dimethylsilyloxy rubber because it is easily available and economical. In order to increase the toughness of a resulting cured product, the core layer may have a glass transition temperature (hereinafter may also be referred to simply as “Tg”) of not higher than 0° C., not higher than −20° C., not higher than −40° C., or not higher than −60° C.

In addition, the volume-average particle size of the core layer is not particularly limited, but may be 0.03 μm to 2 μm, 0.05 μm to 1 μm, 0.12 μm to 0.50 μm, 0.12 μm to 0.28 μm, or 0.14 μm to 0.25 μm. In a case where the volume-average particle size of the core layer is within this range, it is possible to produce the core layer stably, a cured product can have favorable heat resistance and favorable impact resistance. A method of measuring the volume-average particle size of the core layer will be described in detail in Examples later.

The core layer may have a single-layer structure. Alternatively, the core layer may have a multilayer structure that includes layers having rubber elasticity. Further, in a case where the core layer has a multilayer structure, the layers may have differing polymer compositions within the scope of the disclosure.

In one or more embodiments of the present invention, for example, an intermediate layer described in paragraphs [0046] to [0049] in the pamphlet of WO 2016/163491 can be provided between the core layer and the shell layer.

### <<Shell Layer>>

The shell layer is a polymer obtained by polymerizing a monomer for shell layer formation. The polymer (shell polymer) constituting the shell layer serves to improve compatibility between the polymer particles (B) and the component (A) and enable the polymer particles (B) to be dispersed in the form of primary particles in the composition and/or in a cured product of the composition.

The composition of the monomer for shell layer formation, that is, the type and proportion of monomer included in the monomer for shell layer formation, is not particularly limited. In terms of compatibility and dispersibility of the polymer particles (B) in the composition, for example, the monomer for shell layer formation may be an aromatic vinyl-based monomer, a vinyl cyanide-based monomer, or a (meth)acrylate-based monomer, or may be a (meth)acrylate-based monomer. The monomer for shell layer formation may contain methyl methacrylate. One type of these monomers for shell layer formation may be used alone, or two or more types of these monomers for shell layer formation may be used in combination.

In other words, the type and proportion of structural unit included in the shell layer are not particularly limited. In terms of compatibility and dispersibility of the polymer particles (B) in the composition, for example, the shell layer may contain a structural unit derived from at least one type of monomer selected from the group consisting of aromatic vinyl-based monomers, vinyl cyanide-based monomers, and (meth)acrylate-based monomers, or may contain a structural unit derived from a (meth)acrylate-based monomer. The shell layer may contain a structural unit derived from methyl methacrylate.

A total contained amount of the structural unit derived from at least one type of monomer selected from the group consisting of aromatic vinyl-based monomers, vinyl cyanide-based monomers, and (meth)acrylate-based monomers in the shell layer may be 10.0% by mass to 99.5% by mass, 50.0% by mass to 99.0% by mass, 65.0% by mass to 98.0% by mass, 67.0% by mass to 80.0% by mass, or 67.0% by mass to 85.0% by mass, in 100% by mass of the shell layer (shell polymer).

Specific examples of the aromatic vinyl-based monomers encompass vinylbenzenes such as styrene, α-methylstyrene, p-methylstyrene, and divinylbenzene.

Specific examples of the vinyl cyanide-based monomers encompass acrylonitrile and methacrylonitrile.

Specific examples of the (meth)acrylate-based monomers are the same as those described in the section under <<Core Layer>> above. Therefore, the description thereof will be incorporated and will be omitted here.

From the viewpoint of chemically bonding the polymer particles (B) and the component (A) in order to maintain a favorable state of dispersion of the polymer particles (B) in the cured product and in the composition without aggregation of the polymer particles (B), the shell layer may have a structural unit derived from a reactive-group-containing monomer. In other words, the shell layer may contain a reactive group.

For example, the reactive group may be at least one type selected from the group consisting of an epoxy group, an oxetane group, a hydroxy group, an amino group, an imide group, a carboxylic acid group, a carboxylic anhydride group, a cyclic ester, a cyclic amide, a benzoxazine group, and a cyanate ester group.

The reactive group may be an epoxy group because a resulting cured product has excellent adhesive strength and excellent impact-peel-resistant adhesiveness. In other words, the shell layer may have a structural unit derived from a monomer having an epoxy group, that is, the shell layer may have an epoxy group.

Specific examples of the monomer having an epoxy group encompass glycidyl-group-containing vinyl monomers such as glycidyl (meth)acrylates, 4-hydroxybutyl (meth)acrylate glycidyl ethers, and allyl glycidyl ethers.

In the present disclosure, compositions that satisfy at least the item (3), which are, for example, the composition (III), the composition (I)+(III), the composition (II)+(III), and the composition (I)+(II)+(III), each have an essential configuration in which the shell layer of the polymer particles (B) has an epoxy group. The configuration in which the shell layer of the polymer particles (B) has an epoxy group in the composition (III), the composition (I)+(III), the composition (II)+(III), and the composition (I)+(II)+(III) allows the composition (III), the composition (I)+(III), the composition (II)+(III), and the composition (I)+(II)+(III) to have an advantage of making it possible to provide a cured product having excellent adhesive strength by low-temperature curing. The epoxy group of the shell layer in the composition (III), the composition (I)+(III), the composition (II)+(III), and the composition (I)+(II)+(III) also contributes to achievement, by the composition (III), the composition (I)+(III), the composition (II)+(III), and the composition (I)+(II)+(III), of provision of a cured product having excellent impact-peel-resistant adhesiveness by low-temperature curing.

Further, in the present disclosure, in the composition (I), the composition (II), and the composition (I)+(II), the configuration in which the shell layer of the polymer particles (B) has an epoxy group is not essential but optional. In the present disclosure, in the composition (I), the composition (II), and the composition (I)+(II), the shell layer of the polymer particles (B) may have an epoxy group or may not have an epoxy group. In a case where the composition (I), the composition (II), and the composition (I)+(II) each have the configuration in which the shell layer of the polymer particles (B) has an epoxy group, the composition (I), the composition (II), and the composition (I)+(II) each make it possible to provide a cured product having excellent adhesive strength by low-temperature curing and further make it possible to provide a cured product having excellent impact-peel-resistant adhesiveness by low-temperature curing.

In a case where the shell layer of the polymer particles (B) has an epoxy group, a contained amount of the epoxy group which the shell layer has with respect to a total mass of the shell layer of the polymer particles (B) may be more than 0 mmol/g and not more than 2.0 mmol/g, not less than 0.1 mmol/g and not more than 2.0 mmol/g, or not less than 0.3 mmol/g and not more than 1.5 mmol/g, from the viewpoint of adhesive strength and impact-peel-resistant adhesiveness of a resulting cured product and storage stability of the composition. According to this configuration, it is presumed that aggregation of the polymer particles (B) is suppressed, the polymer particles (B) can be dispersed in the cured product in the form of primary particles, and, as a result, the cured product can have improved adhesive strength and improved impact-peel-resistant adhesiveness.

The monomer having an epoxy group may be used in the formation of the shell layer, or used only to form the shell layer. In other words, the core layer and the intermediate layer preferably do not have an epoxy group.

It can be said that the smaller the amount of epoxy group in the shell layer of the polymer particles (B), the more excellent the storage stability of a composition. In other words, from the viewpoint of the storage stability of the composition, for example, the composition (I), the composition (II), and the composition (I)+(II) may be such that the shell layer of the polymer particles (B) does not have an epoxy group.

Specific examples of a monomer having a hydroxyl group as the reactive group-containing monomer encompass the above-described hydroxyalkyl (meth)acrylates.

The shell layer may contain a structural unit derived from a polyfunctional monomer having two or more radical polymerizable double bonds, because such a shell layer prevents swelling of the polymer particles (B) in a composition and allows the composition to tend to have a low viscosity and favorable handleability. However, from the viewpoint of the effect of improving the toughness of a resulting cured product and the effect of improving the impact-peel-resistant adhesiveness of the resulting cured product, it is preferable that the shell layer do not contain a structural unit derived from a polyfunctional monomer having two or more radical polymerizable double bonds.

Specific examples of the polyfunctional monomer do not include conjugated diene-based monomers such as butadiene and encompass: allyl alkyl (meth)acrylates such as allyl (meth)acrylate and allyl alkyl (meth)acrylate; allyl oxyalkyl (meth)acrylates; polyfunctional (meth)acrylates that have two or more (meth)acrylic groups such as (poly)ethylene glycol di(meth)acrylate, butanediol di(meth)acrylate, ethylene glycol di(meth)acrylate, triethylene glycol di(meth)acrylate, and tetraethylene glycol di(meth)acrylate; and diallyl phthalate, triallyl cyanurate, triallyl isocyanurate, and divinylbenzene.

Among these polyfunctional monomers, allyl methacrylate and triallyl isocyanurate are preferable.

For example, the shell layer may be a polymer that includes only the following structural units: (a) 0% by mass to 50% by mass (1% by mass to 50% by mass, or 2% by mass to 48% by mass) of a structural unit derived from an aromatic vinyl-based monomer (or styrene); (b) 0% by mass to 50% by mass (0% by mass to 30% by mass, or 10% by mass to 25% by mass) of a structural unit derived from a vinyl cyanide-based monomer (or acrylonitrile); (c) 0% by mass to 100% by mass (5% by mass to 100% by mass, or 70% by mass to 95% by mass) of a structural unit derived from a (meth)acrylate monomer ((i) at least one type of monomer selected from the group consisting of methyl acrylate, butyl acrylate, and methyl methacrylate, or (ii) methyl methacrylate); and (d) 1% by mass to 50% by mass (2% by mass to 35% by mass, or 3% by mass to 20% by mass) of a structural unit derived from a monomer having an epoxy group (particularly, glycidyl methacrylate). Note, however, that (i) a total of the structural unit derived from an aromatic vinyl-based monomer, the structural unit derived from a vinyl cyanide-based monomer, the structural unit derived from a (meth)acrylate monomer, and the structural unit derived from a monomer having an epoxy group is 100% by mass, and (ii) 0% by mass is intended to mean that a structural unit concerned may not be included.

One type of the above-described monomer components may be used alone, or two or more types of the above-described monomer components may be used in combination. The shell layer may contain a structural unit derived from a monomer which differs from the above-described monomers.

The shell layer may have a single-layer structure. Alternatively, the shell layer may have a multilayer structure. Further, in a case where the shell layer has a multilayer structure, layers of the multilayer structure may have differing polymer compositions within the scope of the disclosure.

### <<Volume-Average Particle Size (Mv) of Polymer Particles (B)>>

The volume-average particle size (Mv) of the polymer particles (B) is not particularly limited, but may be not less than 0.01 μm and not more than 2.00 μm, not less than 0.03 μm and not more than 0.60 μm, not less than 0.05 μm and not more than 0.40 μm, not less than 0.10 μm and not more than 0.30 μm, not less than 0.15 μm and not more than 0.30 μm, not less than 0.16 μm and not more than 0.28 μm, not less than 0.17 μm and not more than 0.27 μm, or not less than 0.18 μm and not more than 0.25 μm, from the viewpoint of industrial productivity and workability of a curable resin composition. In (a) a case where the volume-average particle size (Mv) of the polymer particles (B) is not less than 0.01 μm, a curable resin composition has a low viscosity, and thus favorable workability is achieved. In (b) a case where the volume-average particle size (Mv) of the polymer particles (B) is not more than 2.00 μm, a polymerization time of the component (B) becomes short, and high industrial productivity is achieved. A method of measuring the volume-average particle size (Mv) of the polymer particles (B) will be described in detail in Examples later.

The polymer particles (B) may be dispersed in the form of primary particles in the composition. In the present specification, “polymer particles (B) are dispersed in the form of primary particles” (hereinafter also referred to as “primary dispersion”) means that polymer particles (B) are dispersed so as to be substantially independent from each other (not in contact). This state of dispersion can be confirmed by, for example, dissolving part of the composition in a solvent such as methyl ethyl ketone, and subjecting a resulting solution to, for example, a particle size measurement apparatus by laser beam scattering to measure the particle size of the polymer particles (B) in the composition.

Further, “stable dispersion” of the polymer particles (B) means a state in which the polymer particles (B) are, under normal conditions, in a steady state of dispersion over a long period without aggregating, separating, or precipitating in a continuous layer. In addition, (i) the distribution of the polymer particles (B) in a continuous layer remain substantially unchanged, and (ii) “stable dispersion” of the polymer particles (B) may be maintained even when the composition containing these polymer particles (B) is heated to a non-dangerous degree so as to lower the viscosity of the composition, and the composition is stirred.

One type of polymer particles (B) may be used alone, or two or more types of polymer particles (B) may be used in combination.

### <Method for Producing Core-Shell Polymer Particles>

### (Method for Producing Core Layer)

The core layer included in the polymer particles (B) can be formed by, for example, a method such as an emulsion polymerization method, a suspension polymerization method, or a microsuspension polymerization method. As the method such as an emulsion polymerization method, a suspension polymerization method, or a microsuspension polymerization method, for example, the methods described in International Publication No. WO 2005/028546 and International Publication No. WO 2006/070664 can be utilized as appropriate.

### (Method for Forming Shell Layer and Intermediate Layer)

The intermediate layer can be formed by polymerizing, by known radical polymerization, a monomer for intermediate layer formation. In a case where a rubber elastic body to be included in the core layer is obtained as an emulsion, the monomer for intermediate layer formation may be polymerized by an emulsion polymerization method.

The shell layer can be formed by polymerizing, by known radical polymerization, a monomer for shell layer formation. In a case where the core layer or a polymer particle precursor in which the core layer is covered with the intermediate layer is obtained as an emulsion, the monomer for shell layer formation may be polymerized by an emulsion polymerization method. As the emulsion polymerization method, for example, the method described in International Publication No. WO 2005/028546 can be utilized as appropriate.

In the emulsion polymerization, an emulsifying agent (dispersion agent) is used.

Examples of the emulsifying agent encompass (i) anionic emulsifying agents (dispersion agents) such as (i-1) various acids including: alkyl or aryl sulfonic acids typified by dioctylsulfosuccinic acid, dodecylbenzenesulfonic acid, and the like; alkyl or arylether sulfonic acids; alkyl or arylsulfuric acids typified by dodecylsulfuric acids; alkyl or arylether sulfuric acids; alkyl or aryl-substituted phosphoric acids; alkyl or arylether-substituted phosphoric acids; N-alkyl or arylsarcosinic acids typified by dodecylsarcosinic acid; alkyl or arylcarboxylic acids typified by oleic acid, stearic acid, and the like; and alkyl or arylether carboxylic acids and (i-2) alkali metal salts or ammonium salts of these acids, (ii) nonionic emulsifying agents (dispersion agents) such as alkyl or aryl-substituted polyethylene glycols, and (iii) dispersion agents such as polyvinyl alcohols, alkyl-substituted celluloses, polyvinylpyrrolidone, and polyacrylic acid derivatives.

One type of these emulsifying agents (dispersion agents) may be used alone, or two or more types of these emulsifying agents (dispersion agents) may be used in combination.

A smaller used amount of the emulsifying agent (dispersion agent) is more preferable, as long as there is no negative effect on dispersion stability of an aqueous latex of the polymer particles. A higher water solubility of the emulsifying agent (dispersion agent) is more preferable. A high water solubility facilitates removal of the emulsifying agent (dispersion agent) by washing and makes it possible to easily prevent adverse effects on a cured product that is ultimately obtained.

In a case where the emulsion polymerization method is employed, for example, a peroxide (for example, an organic peroxide), a chain transfer agent, and a surfactant can be used as necessary.

As conditions of polymerization such as polymerization temperature, pressure, and deoxygenation, conditions within known ranges can be employed.

A contained amount of the polymer particles (B) in the present composition may be 1 part by mass to 100 parts by mass, 5 parts by mass to 90 parts by mass, 10 parts by mass to 80 parts by mass, 20 parts by mass to 70 parts by mass, or 30 parts by mass to 60 parts by mass, with respect to 100 parts by mass of the epoxy resin (A), because an excellent balance is achieved between storage stability of a resulting composition and the effect of improving the toughness of a resulting cured product.

### <Dicyandiamide (C)>

The dicyandiamide (C) can function as a curing agent that cures a composition. At a temperature of at least lower than 100° C., the dicyandiamide (C) does not exhibit a curing action or progresses a curing reaction very slowly even if the dicyandiamide (C) exhibits the curing action. On the other hand, when heated to a temperature of not lower than 100° C. (or a temperature of 120° C.), the dicyandiamide (C) exhibits a curing action and can rapidly cure a composition.

As described above, at a temperature of about room temperature, the component (C) does not exhibit a curing action or exhibits a curing action very slowly even if the component (C) exhibits the curing action. Thus, the present composition is free from a risk of being unintentionally cured during storage even though the present composition is a one-pack type thermosetting composition. In other words, it can be said that the present composition has excellent storage stability by containing the component (C) as a curing agent.

The present composition may contain the component (C) in an amount of 3.5 parts by mass to 19.0 parts by mass, 3.5 parts by mass to 18.0 parts by mass, 4.0 parts by mass to 16.0 parts by mass, 4.5 parts by mass to 14.0 parts by mass, 5.0 parts by mass to 12.0 parts by mass, 5.5 parts by mass to 10.0 parts by mass, or 6.0 parts by mass to 8.0 parts by mass, with respect to 100 parts by mass of the epoxy resin (A). In (a) a case where the contained amount of the component (C) is not less than 3.5 parts by mass with respect to 100 parts by mass of the epoxy resin (A), there is an advantage in that a cured product obtained by curing the present composition at a low temperature has sufficient adhesive strength. In (b) a case where the contained amount of the component (C) is not more than 19.0 parts by mass with respect to 100 parts by mass of the epoxy resin (A), there is an advantage in that the present composition has favorable storage stability.

### <Amine Adduct Curing Agent (D)>

The amine adduct curing agent (D) can function as a curing agent that cures a composition. The amine adduct curing agent (D) is a compound that is a solid which is insoluble in the epoxy resin (A) at room temperature (for example, 25° C.), that is soluble in the epoxy resin (A) by being heated, and that functions as a curing agent for the epoxy resin (A). The amine adduct curing agent (D) can be said to be a latent curing agent and, more specifically, can be said to be a latent modified polyamine-based curing agent that is a solid at room temperature.

At a temperature of at least lower than 80° C., the amine adduct curing agent (D) does not exhibit a curing action or progresses a curing reaction very slowly even if the amine adduct curing agent (D) exhibits the curing action. On the other hand, when heated to a temperature of not lower than 80° C. (or a temperature of 120° C.), the amine adduct curing agent (D) may exhibit a curing action and can rapidly cure a composition.

As described above, at a temperature of about room temperature, the component (D) does not exhibit a curing action or exhibits a curing action very slowly even if the component (D) exhibits the curing action. Thus, the present composition is free from a risk of being unintentionally cured during storage even though the present composition is a one-pack type thermosetting composition. In other words, it can be said that the present composition has excellent storage stability by containing the component (D) as a curing agent.

Examples of the amine adduct curing agent (D) encompass: amine-epoxy adduct curing agents (such as, for example, AMICURE PN23, PN31, PN40, PN50, PN-H manufactured by Ajinomoto Fine-Techno Co., Inc., AJICURE PN23, PN31, PN40, PN50, PN-H manufactured by Ajinomoto Fine-Techno Co., Inc., Hardener X-3661S, X-3670S manufactured by A.C.R. TECH CO., LTD., NOVACURE HX-3742, HX-3721 manufactured by Asahi Kasei Corporation, and ADEKA HARDNER EH3293S, EH3366S, EH4346S manufactured by ADEKA CORPORATION) which is a reaction product of an amine compound and an epoxy compound; and urea type adduct curing agents (such as, for example, FUJICURE FXR-1020, FXR-1121, FXR-1081, 1061, 1171 manufactured by T&K TOKA (Fuji Kasei Co., Ltd.)) which is a reaction product of an amine compound and an isocyanate compound or an urea compound. The amine-epoxy adduct curing agent may also be referred to as epoxy compound adduct curing agent.

The amine adduct curing agent (D) may contain at least one type selected from the group consisting of amine-epoxy adduct curing agents and urea adduct curing agents, or may contain at least one type selected from amine-epoxy adduct curing agents, because a composition has excellent fast curability at a low temperature, and a cured product obtained by curing the composition has excellent heat resistance.

The amine adduct curing agent (D) may contain at least one type selected from the group consisting of amine-epoxy adduct curing agents in an amount of not less than 70% by mass, not less than 80% by mass, or not less than 90% by mass, in 100% by mass of the amine adduct curing agent (D).

The amine adduct curing agent (D) may be constituted only by at least one type selected from the group consisting of amine-epoxy adduct curing agents and urea adduct curing agents, may be constituted only by at least one type selected from the group consisting of urea adduct curing agents, and may be constituted only by at least one type selected from the group consisting of amine-epoxy adduct curing agents.

In the course of diligent studies, the inventor of one or more embodiments of the present invention has obtained, on his own, a novel finding that the softening temperature and particle size of the amine adduct curing agent (D) can affect the adhesive strength of a cured product and the storage stability of a composition.

The amine adduct curing agent (D) may contain an amine adduct curing agent having a softening temperature of 80° C. to 140° C. Such a configuration has an advantage of allowing a cured product to have an excellent balance between adhesive strength and storage stability. Examples of the amine adduct curing agent having a softening temperature of 80° C. to 140° C. encompass: (i) Amicure PN-23 (95° C.), Amicure PN-23J (95° C.), Amicure PN-H (102° C.), Amicure PN-40 (108° C.), Amicure PN-40J (106° C.), Amicure PN-31J (109° C.), Amicure PN-50 (115° C.), Amicure MY-24 (120° C.), Ajicure PN-23 (95° C.), Ajicure PN-23J (95° C.), Ajicure PN-H (102° C.), Ajicure PN-40 (108° C.), Ajicure PN-40J (106° C.), Ajicure PN-31J (109° C.), Ajicure PN-50 (115° C.), and Ajicure MY-24 (120° C.), each manufactured by Ajinomoto Fine-Techno Co., Inc.; and (ii) Fujicure-FXR-1020 (120° C. to 130° C.), Fujicure-FXR-1081 (115° C. to 125° C.), Fujicure-1061 (90° C. to 110° C.), Fujicure-FXR-1121 (128° C. to 138° C.), and Fujicure-1171 (105° C. to 115° C.), each manufactured by T&K TOKA (Fuji Kasei Co., Ltd.) (Temperatures within parentheses are intended to mean softening temperatures).

The amine adduct curing agent (D) may contain an amine adduct curing agent having a softening temperature of 80° C. to 140° C. in an amount of not less than 70% by mass, not less than 80% by mass, or not less than 90% by mass, in 100% by mass of the amine adduct curing agent (D). The amine adduct curing agent (D) may contain an amine adduct curing agent having a softening temperature of 80° C. to 140° C. in an amount of 100% by mass in 100% by mass of the amine adduct curing agent (D). In other words, the amine adduct curing agent (D) may be constituted only by an amine adduct curing agent having a softening temperature of 80° C. to 140° C.

The softening temperature of the amine adduct curing agent contained in the amine adduct curing agent (D) may be 90° C. to 130° C., 100° C. to 125° C., or 105° C. to 120° C., because such a softening temperature allows a cured product to have a more excellent balance between adhesive strength and storage stability.

The amine adduct curing agent (D) may contain an amine adduct curing agent having a volume-average particle size of 1 μm to 50 μm. Such a configuration has an advantage of allowing a cured product to have an excellent balance between adhesive strength and storage stability. Here, the “volume-average particle size” of the amine adduct curing agent is intended to mean a particle size at which the cumulative volume reaches 50% when particle sizes of the amine adduct curing agent measured on the volume basis by use of a laser diffraction method are accumulated in increasing order of particle size.

The amine adduct curing agent (D) may contain an amine adduct curing agent having a volume-average particle size of 1 μm to 50 μm in an amount of not less than 70% by mass, not less than 80% by mass, or not less than 90% by mass, in 100% by mass of the amine adduct curing agent (D). The amine adduct curing agent (D) may contain an amine adduct curing agent having a volume-average particle size of 1 μm to 50 μm in an amount of 100% by mass in 100% by mass of the amine adduct curing agent (D). In other words, the amine adduct curing agent (D) may be constituted only by an amine adduct curing agent having a volume-average particle size of 1 μm to 50 μm.

The volume-average particle size of the amine adduct curing agent contained in the amine adduct curing agent (D) may be 3 μm to 30 μm, 4 μm to 25 μm, or 5 μm to 20 μm, because such a volume-average particle size allows a cured product to have a more excellent balance between adhesive strength and storage stability.

The present composition contains the component (D) in an amount of 0.3 parts by mass to 10.0 parts by mass with respect to 100 parts by mass of the epoxy resin (A). In (a) a case where the contained amount of the component (D) in the present composition is not less than 0.3 parts by mass with respect to 100 parts by mass of the epoxy resin (A), there is an advantage in that a cured product obtained by curing the present composition at a low temperature has sufficient adhesive strength. In (b) a case where the contained amount of the component (D) is not more than 10.0 parts by mass with respect to 100 parts by mass of the epoxy resin (A), there is an advantage in that the present composition has favorable storage stability.

In the present disclosure, at least one composition selected from the group consisting of the composition (I), the composition (I)+(II), the composition (I)+(III), and the composition (I)+(II)+(III) may contain the component (D) in an amount of 0.3 parts by mass to 3.5 parts by mass, 0.4 parts by mass to 2.8 parts by mass, 0.4 parts by mass to 2.3 parts by mass, or 0.5 parts by mass to 1.8 parts by mass, with respect to 100 parts by mass of the epoxy resin (A). On the other hand, in the present disclosure, at least one composition selected from the group consisting of the composition (II), the composition (III), and the composition (II)+(III) may contain the component (D) in an amount of 0.5 parts by mass to 9.0 parts by mass, 0.6 parts by mass to 8.0 parts by mass, 0.8 parts by mass to 7.0 parts by mass, or 1.0 part by mass to 6.0 parts by mass, with respect to 100 parts by mass of the epoxy resin (A).

The present composition may contain a curing agent other than the component (C) and the component (D). For example, the present composition may contain a latent curing agent other than the component (C) and the component (D). Examples of the latent curing agent other than the component (C) and the component (D) encompass an N-containing curing agent such as specific amine-based curing agents (including imine-based curing agents). Examples of the N-containing curing agent other than the component (C) and the component (D) encompass a boron trichloride/amine complex, a boron trifluoride/amine complex, melamine, diallyl melamine, guanamine, aminotriazole, hydrazide, cyanoacetamide, imidazole, and aromatic polyamine.

The contained amount of the curing agent other than the component (C) and the component (D) in the present composition may be not more than 5.0% by mass, not more than 2.0% by mass, not more than 1.0% by mass, or not more than 0.5% by mass, in 100% by mass of the composition, because such a contained amount allows a cured product to have a particularly excellent balance between adhesive strength and storage stability. In the present composition, the curing agent may be constituted only by the component (C) and the component (D).

### <Urea Compound (E)>

The urea compound may be a substance (compound) that contains urea bonds in a molecule and that makes it possible to accelerate curing of a composition. The urea compound (E) can also be said to be a curing accelerator.

In the present disclosure, compositions that satisfy at least the item (1), which are, for example, the composition (I), the composition (I)+(II), the composition (I)+(III), and the composition (I)+(II)+(III), each contain the urea compound (E) as an essential component. In the composition (II), the composition (III), and the composition (II)+(III), the urea compound (E) is an optional component. The composition (II), the composition (III), and the composition (II)+(III) may each contain the urea compound (E).

The urea compound (E) is represented by general formula (X):

R¹—NH—C(═O)—N—R²₂ (X)
where R¹ is a substituted or unsubstituted hydrocarbon group having 1 to 20 carbon atoms, and two R² are each independently a substituted or unsubstituted hydrocarbon group having 1 to 20 carbon atoms.

Note that, in the present specification, the amine adduct curing agent such as a urea adduct curing agent is contained in the component (D), not in the urea compound (E).

The urea compound (E) can be suitably at least one type selected from the group consisting of, for example, 3-(3,4-dichlorophenyl)-1,1-dimethylurea (e.g., Dyhard UR200 manufactured by AlzChem), 3,3′-[methylenebis(4,1-phenylene)]bis(1,1-dimethylurea) (e.g., Omicure 52 manufactured by Huntsman), 1,1′-(4-methyl-1,3-phenylene)bis(3,3-dimethylurea) (e.g., Dyhard UR500 manufactured by AlzChem), 4,4′-methylenebisphenyl dimethylurea, p-chlorophenyl-N,N-dimethyl urea (e.g., product name: Monuron), N-(3-chloro-4-methylphenyl)-N′,N′-dimethyl urea (e.g., product name: Chlortoluron), and 1,1-dimethylphenylurea (e.g., Dyhard UR300 manufactured by AlzChem).

The urea compound (E) may contain at least one type selected from the group consisting of 3-(3,4-dichlorophenyl)-1,1-dimethylurea, 3,3′-[methylenebis(4,1-phenylene)]bis(1,1-dimethylurea), and 1,1′-(4-methyl-1,3-phenylene)bis(3,3-dimethylurea), 3-(3,4-dichlorophenyl)-1,1-dimethylurea and/or 3,3′-[methylenebis(4,1-phenylene)]bis(1,1-dimethylurea), or 3-(3,4-dichlorophenyl)-1,1-dimethylurea. Such a configuration has an advantage of allowing a cured product to have an excellent balance between adhesive strength and storage stability.

The urea compound (E) may contain at least one type selected from the group consisting of 3-(3,4-dichlorophenyl)-1,1-dimethylurea, 3,3′-[methylenebis(4,1-phenylene)]bis(1,1-dimethylurea), and 1,1′-(4-methyl-1,3-phenylene)bis(3,3-dimethylurea) in an amount of not less than 70% by mass, not less than 80% by mass, or not less than 90% by mass, in 100% by mass of the urea compound (E). The urea compound (E) may contain at least one type selected from the group consisting of 3-(3,4-dichlorophenyl)-1,1-dimethylurea, 3,3′-[methylenebis(4,1-phenylene)]bis(1,1-dimethylurea), and 1,1′-(4-methyl-1,3-phenylene)bis(3,3-dimethylurea) in an amount of 100% by mass in 100% by mass of the urea compound (E). In other words, the urea compound (E) may be constituted only by at least one type selected from the group consisting of 3-(3,4-dichlorophenyl)-1,1-dimethylurea, 3,3′-[methylenebis(4,1-phenylene)]bis(1,1-dimethylurea), and 1,1′-(4-methyl-1,3-phenylene)bis(3,3-dimethylurea). Further, the urea compound (E) may be constituted only by 3-(3,4-dichlorophenyl)-1,1-dimethylurea and/or 3,3′-[methylenebis(4,1-phenylene)]bis(1,1-dimethylurea) and may be constituted only by 3-(3,4-dichlorophenyl)-1,1-dimethylurea.

The composition (I) contains the component (E) in an amount of 0.5 parts by mass to 15.0 parts by mass with respect to 100 parts by mass of the epoxy resin (A). The present composition, which is, for example, the composition (I), the composition (I)+(II), the composition (I)+(III), and the composition (I)+(II)+(III), may contain the component (E) in an amount of 0.5 parts by mass to 15.0 parts by mass, 0.7 parts by mass to 13.0 parts by mass, 0.9 parts by mass to 11.0 parts by mass, 1.0 part by mass to 10.0 parts by mass, 1.2 parts by mass to 9.0 parts by mass, 1.4 parts by mass to 7.0 parts by mass, or 1.5 parts by mass to 6.0 parts by mass, with respect to 100 parts by mass of the epoxy resin (A). In (a) a case where the contained amount of the component (E) in the present composition is not less than 0.5 parts by mass with respect to 100 parts by mass of the epoxy resin (A), there is an advantage in that a cured product obtained by curing the present composition at a low temperature has sufficient adhesive strength. In (b) a case where the contained amount of the component (E) is not more than 15.0 parts by mass with respect to 100 parts by mass of the epoxy resin (A), there is an advantage in that the present composition has favorable storage stability.

In the present composition, a total contained amount of the component (D) and the component (E) may be 0.8 parts by mass to 25.0 parts by mass, 1.0 part by mass to 16.5 parts by mass, 1.2 parts by mass to 14.5 parts by mass, 1.4 parts by mass to 12.3 parts by mass, 1.5 parts by mass to 11.3 parts by mass, 1.6 parts by mass to 9.8 parts by mass, 1.8 parts by mass to 8.3 parts by mass, or 2.0 parts by mass to 7.8 parts by mass, with respect to 100 parts by mass of the epoxy resin (A). In (a) a case where the total contained amount of the component (D) and the component (E) in the present composition is not less than 0.8 parts by mass with respect to 100 parts by mass of the epoxy resin (A), there is an advantage in that a cured product obtained by curing the present composition at a low temperature has sufficient adhesive strength. In (b) a case where the total contained amount of the component (D) and the component (E) is not more than 25.0 parts by mass with respect to 100 parts by mass of the epoxy resin (A), there is an advantage in that the present composition has favorable storage stability. In the course of diligent studies, the inventor of one or more embodiments of the present invention has obtained, on his own, a finding that, in a case where the total contained amount of the component (D) and the component (E) in the present composition is not more than 7.8 parts by mass with respect to 100 parts by mass of the epoxy resin (A), the present composition has particularly favorable storage stability.

The present composition may contain a curing accelerator other than the component (E). Examples of the curing accelerator other than the component (E) encompass tertiary amines, imidazoles, and 6-caprolactam.

The contained amount of the curing accelerator other than the component (E) in the present composition may be not more than 5.0% by mass, not more than 2.0% by mass, not more than 1.0% by mass, or not more than 0.5% by mass, in 100% by mass of the composition, because such a contained amount allows a cured product to have a particularly excellent balance between adhesive strength and storage stability. In the present composition, the curing accelerator may be constituted only by the component (E).

### <Epoxy-Based Reactive Diluent (F)>

In the present specification, the “epoxy-based reactive diluent” is intended to mean a compound that has an epoxy group and that has a viscosity at 25° C. of not more than 500 mPa-s.

In the present disclosure, compositions that satisfy at least the item (2), which are, for example, the composition (II), the composition (I)+(II), the composition (II)+(III), and the composition (I)+(II)+(III), each contain the epoxy-based reactive diluent (F) as an essential component. In the composition (I), the composition (III), and the composition (I)+(III), the epoxy-based reactive diluent (F) is an optional component. The composition (I), the composition (III), and the composition (I)+(III) may each contain the epoxy-based reactive diluent (F).

Examples of the epoxy-based reactive diluent (F) encompass polyalkylene glycol diglycidyl ether, glycol diglycidyl ether, diglycidyl ester of aliphatic polybasic acid, glycidyl ether of a polyvalent aliphatic alcohol having bivalency or greater valency, and monoepoxide.

More specific examples of the polyalkylene glycol diglycidyl ether encompass polyethylene glycol diglycidyl ether, and polypropylene glycol diglycidyl ether. More specific examples of the glycol diglycidyl ether encompass neopentyl glycol diglycidyl ether, 1,4-butanediol diglycidyl ether, 1,6-hexanediol diglycidyl ether, and cyclohexane dimethanol diglycidyl ether. More specific examples of the diglycidyl ester of an aliphatic polybasic acid encompass dimer acid diglycidyl ester, adipic acid diglycidyl ester, sebacic acid diglycidyl ester, and maleic acid diglycidyl ester. More specific examples of the glycidyl ether of a polyvalent aliphatic alcohol having bivalency or greater valency encompass trimethylolpropane triglycidyl ether, trimethylolethane triglycidyl ether, castor oil-modified polyglycidyl ether, propoxylated glycerine triglycidyl ether, and sorbitol polyglycidyl ether.

Examples of the monoepoxide encompass: aliphatic glycidyl ethers such as butyl glycidyl ether; aromatic glycidyl ethers such as phenyl glycidyl ether and cresyl glycidyl ether (o-cresyl glycidyl ether); ethers composed of an alkyl group having 8 to 10 carbon atoms and a glycidyl group, such as 2-ethylhexyl glycidyl ether; ethers composed of a glycidyl group and a phenyl group having 6 to 12 carbon atoms that can be substituted with an alkyl group having 2 to 8 carbon atoms, such as p-tert-buthylphenyl glycidyl ether; ethers composed of an alkyl group having 12 to 14 carbon atoms and a glycidyl group, such as dodecyl glycidyl ether (alkyl C12-C14 glycidyl ether); aliphatic glycidyl esters such as glycidyl (meth)acrylate and glycidyl maleate; glycidyl esters of aliphatic carboxylic acids having 8 to 12 carbon atoms, such as versatic acid glycidyl ester, neodecanoic acid glycidyl ester, and lauric acid glycidyl ester; and glycidyl p-t-butylbenzoate.

The epoxy-based reactive diluent (F) may contain an epoxy-based reactive diluent having one epoxy group in one molecule. Such a configuration has an advantage of allowing a cured product to have excellent impact-peel-resistant adhesiveness and allowing a composition to have more excellent storage stability. Examples of the epoxy-based reactive diluent having one epoxy group in one molecule encompass neodecanoic acid glycidyl ester, phenyl glycidyl ether, cresyl glycidyl ether, 4-tert-butylphenyl glycidyl ether, and 2-ethylhexyl glycidyl ether. The epoxy-based reactive diluent (F) may contain an epoxy-based reactive diluent having one epoxy group in one molecule in an amount of not less than 70% by mass, not less than 80% by mass, or not less than 90% by mass, in 100% by mass of the epoxy-based reactive diluent (F). The epoxy-based reactive diluent (F) may contain an epoxy-based reactive diluent having one epoxy group in one molecule in an amount of 100% by mass in 100% by mass of the epoxy-based reactive diluent (F). In other words, the epoxy-based reactive diluent (F) may be constituted only by an epoxy-based reactive diluent having one epoxy group in one molecule.

As the epoxy-based reactive diluent (F), a commercially available product can be used. Examples of the commercially available product of the epoxy-based reactive diluent (F) encompass YED216M (manufactured by Mitsubishi Chemical Corporation; 1,6-hexanediol diglycidyl ether), Cardura E10P (manufactured by Hexion; neodecanoic acid glycidyl ester), ERISYS GE-10 (manufactured by Huntsman; o-cresyl glycidyl ether), 4-tert-butylphenyl glycidyl ether (manufactured by Tokyo Chemical Industry Co., Ltd.), ERISYS GE-6 (manufactured by Huntsman; 2-ethylhexyl glycidyl ether), ERISYS GE-8 (manufactured by Huntsman; alkyl C12-C14 glycidyl ether), ERISYS GE-20 (manufactured by Huntsman; neopentyl glycol diglycidyl ether), ERISYS GE-21 (manufactured by Huntsman; 1,4-butanediol diglycidyl ether) and ERISYS GE-24 (manufactured by Huntsman; polypropylene glycol diglycidyl ether). Note that Cardura E10P, ERISYS GE-10, 4-tert-butylphenyl glycidyl ether, ERISYS GE-6, and ERISYS GE-8 are each an epoxy-based reactive diluent having one epoxy group in one molecule.

The composition (II) contains the component (F) in an amount of 1.0 part by mass to 20.0 parts by mass with respect to 100 parts by mass of the epoxy resin (A). The present composition, which is, for example, the composition (II), the composition (I)+(II), the composition (II)+(III), and the composition (I)+(II)+(III), may contain the component (F) in an amount of 1.0 part by mass to 20.0 parts by mass, 2.0 parts by mass to 18.0 parts by mass, 4.0 parts by mass to 16.0 parts by mass, 6.0 part by mass to 14.0 parts by mass, or 8.0 parts by mass to 12.0 parts by mass, with respect to 100 parts by mass of the epoxy resin (A). In a case where the contained amount of the component (F) in the present composition is within the above-described range, there is an advantage in that a cured product obtained by curing the present composition at a low temperature has sufficient adhesive strength.

A ratio (Wc/We) of a total mass Wc of the dicyandiamide (C) to a total mass We of the urea compound (E) may be 1.1 to 20.0, 1.1 to 10.0, 1.2 to 5.0, or 1.2 to 3.0. Such a configuration has an advantage of allowing a cured product obtained by curing the present composition at a low temperature to have more excellent adhesive strength.

A ratio (We/Wd) of the total mass We of the urea compound (E) to a total mass Wd of the amine adduct curing agent (D) may be 1.1 to 20.0, 1.5 to 15.0, 2.0 to 10.0, or 2.5 to 5.0. Such a configuration has an advantage of allowing a cured product obtained by curing the present composition at a low temperature to have more excellent adhesive strength. Further, in the course of diligent studies, the inventor of one or more embodiments of the present invention has obtained, on his own, a novel finding that, in a case where the ratio between We and Wd is within the above-described range, surprisingly, improved impact-peel-resistant adhesiveness and increased shear rate dependency of the viscosity are achieved. Conventionally, the technical idea that the amine adduct curing agent (D) and the urea compound (E) are used in combination has not been known. Thus, the above-described finding can be said to be a finding that could not be predicted from the conventional technique.

### <Inorganic Filler>

The present composition may contain an inorganic filler. The present composition, by containing an inorganic filler, brings about the effect of allowing a resulting cured product to have more excellent rigidity at a high temperature.

Examples of the inorganic filler encompass: silicic acids and/or silicates such as dry silica, wet silica, aluminum silicate, magnesium silicate, calcium silicate; reinforcing fillers such as wollastonite, talc, dolomite, and carbon black; and fillers such as ground calcium carbonate, colloidal calcium carbonate, magnesium carbonate, titanium oxide, ferric oxide, aluminum fine powder, zinc oxide, and active zinc flower.

Among these, wollastonite is preferable because there is an advantage in that a resulting cured product has even more excellent rigidity at a high temperature. As the inorganic filler, fumed silica and calcium carbonate are also preferable. One type of the above-described inorganic fillers may be used alone, or two or more types of the above-described inorganic fillers may be used in combination.

The dry silica is also referred to as fumed silica. Examples of the dry silica encompass non-surface-treated hydrophilic fumed silica and hydrophobic fumed silica which is produced by treating a silanol group part of hydrophilic fumed silica with silane and/or siloxane. The dry silica may be hydrophobic fumed silica in terms of dispersibility in the epoxy resin (A).

The inorganic filler may be surface-treated with a surface treating agent. Surface treatment improves the dispersibility of the inorganic filler in a composition and, as a result, improves various physical properties of a resulting cured product.

A contained amount of the inorganic filler in the present composition may be 1 part by mass to 300 parts by mass, 5 parts by mass to 200 parts by mass, or 10 parts by mass to 150 parts by mass, with respect to 100 parts by mass of the epoxy resin (A). In a case where the contained amount of the inorganic filler is within the above-described range, there is an advantage in that a resulting cured product has even more excellent rigidity at a high temperature and has even more excellent adhesive strength.

Note that, in the present specification, calcium oxide which will be described later is not contained in the inorganic filler. That is, in a case where the present composition contains the inorganic filler and calcium oxide, the amount of the calcium oxide is not added to the contained amount of the inorganic filler.

### <Calcium Oxide>

The present composition may contain calcium oxide. In a case where the present composition contains calcium oxide, calcium oxide removes moisture from the composition by reacting with the moisture in the composition, and thereby can ameliorate moisture-caused problems regarding various properties. The calcium oxide can, for example, serve as a bubble-preventing agent by removing moisture, and prevent or reduce a decrease in the adhesive strength of a resulting cured product.

The calcium oxide can be surface-treated with a surface treating agent. Surface treatment improves the dispersibility of calcium oxide in a composition. As a result, properties such as adhesive strength of a resulting cured product are improved, as compared to a case where non-surface-treated calcium oxide is used. The surface treating agent is not particularly limited and may be a fatty acid.

One type of calcium oxide may be used alone, or two or more types of calcium oxides may be used in combination. Further, surface-treated calcium oxide and non-surface-treated calcium oxide may be used in combination.

A contained amount of the calcium oxide in the present composition may be 0.1 parts by mass to 10.0 parts by mass, 0.2 parts by mass to 5.0 parts by mass, 0.5 parts by mass to 3.0 parts by mass, or 1.0 part by mass to 2.0 parts by mass, with respect to 100 parts by mass of the epoxy resin (A). Setting the contained amount of the calcium oxide in the present composition to be not less than 0.1 parts by mass provides a favorable effect of moisture removal. Setting the contained amount of the calcium oxide to be not more than 10.0 parts by mass increases the strength of a resulting cured product.

### <Other Components>

The present composition may contain other components as necessary. Examples of the other components encompass: a phenol compound; a blocked urethane; a reinforcing agent; a radically curable resin; a monoepoxide; a photopolymerization initiator; an expanding agent such as an azo type chemical foaming agent and thermally expandable microballoons; fiber pulp such as aramid-based pulp; a coloring agent such as a pigment and a colorant; an extender; an ultraviolet ray absorbing agent; an antioxidant; a stabilizer (antigelling agent); a plasticizing agent; a leveling agent; a defoaming agent; a silane coupling agent; an antistatic agent; a flame retarder; a lubricant; a viscosity reducer; a shrinkage reducing agent; an organic filler; a thermoplastic resin; a desiccant; and a dispersion agent.

### (Blocked Urethane)

The present composition may contain a blocked urethane as necessary. As the blocked urethane, for example, the compounds described in paragraphs [0079] to [0107] in the pamphlet of WO 2016/163491 can be used.

### <DSC Parameter>

The present composition has an exothermic onset temperature of not lower than 80° C. and an exothermic peak temperature of not higher than 150° C. in a DSC curve of the one-component type thermosetting resin composition as measured with use of a differential scanning calorimeter under a condition that a temperature increase rate is 10° C./min.

It can be said that the higher the exothermic onset temperature of a composition, the more favorable the storage stability of the composition. The exothermic onset temperature of the present composition may be not lower than 80° C., not lower than 85° C., not lower than 90° C., not lower than 92° C., not lower than 95° C., not lower than 97° C., or not lower than 100° C. It can be said that the lower the exothermic onset temperature of a composition, the lower the temperature at which the composition can be cured. An upper limit value of the exothermic onset temperature of the present composition is not particularly limited. The exothermic onset temperature of the present composition may be not higher than 135° C., not higher than 130° C., not higher than 125° C., not higher than 120° C., not higher than 115° C., not higher than 113° C., not higher than 112° C., or not higher than 110° C.

It can be said that the lower the exothermic peak temperature of a composition, the lower the temperature at which the composition can be cured. The exothermic peak temperature of the present composition may be not higher than 150° C., not higher than 147° C., not higher than 145° C., or not higher than 141° C. A higher exothermic peak temperature of a composition has an advantage of allowing the composition to have more favorable storage stability. The exothermic peak temperature of the present composition may be not lower than 120° C., not lower than 125° C., not lower than 130° C., not lower than 132° C., not lower than 134° C., or not lower than 138° C.

The composition having the exothermic onset temperature and/or the exothermic peak temperature in the above-described range(s) has an advantage of making it possible to provide a cured product having excellent adhesive strength by low-temperature curing and an advantage of having excellent storage stability. The exothermic onset temperature and the exothermic peak temperature can be affected by, for example, the structure of the amine adduct curing agent (D) (in other words, the type of the amine adduct curing agent (D)), the added amount of the amine adduct curing agent (D), the structure of the urea compound (E), the added amount of the urea compound (E), and the like. In other words, the exothermic onset temperature and the exothermic peak temperature can be adjusted as appropriate by changing and adjusting the structure of the amine adduct curing agent (D), the added amount of the amine adduct curing agent (D), the structure of the urea compound (E) (in other words, the type of the urea compound (E)), the added amount of the urea compound (E), the structure of the epoxy-based reactive diluent (F) (in other words, the type of the epoxy-based reactive diluent (F)), the added amount of the epoxy-based reactive diluent (F), and the like.

### <Production Method for Composition>

A method for producing the present composition is not particularly limited, and various methods can be utilized. Examples of the methods encompass: a method in which the polymer particles (B) obtained in the state of aqueous latex are brought into contact with the epoxy resin (A), and then unnecessary components such as water are removed from the resulting mixture; and a method in which the polymer particles (B) are extracted into an organic solvent, the extracted polymer particles (B) are mixed with the epoxy resin (A), and then the organic solvent is removed from the resulting mixture. As such a production method, specifically, the method described in International Publication No. WO 2005/028546 may be utilized. More specifically, the present composition may be prepared by a production method including the following first to third steps:
a first step of mixing an aqueous latex containing the polymer particles (B) (specifically, a reaction mixture obtained by producing the polymer particles (B) by emulsion polymerization) into an organic solvent whose water solubility at 20° C. is 5% by mass to 40% by mass, and then further mixing a resultant mixture with an excess amount of water so as to aggregate the polymer particles (B);
a second step of separating and collecting the aggregated polymer particles (B) from a liquid phase, and then once again mixing the polymer particles (B) into the organic solvent so as to obtain an organic solvent solution of the polymer particles (B); and
a third step of further mixing the organic solvent solution of the polymer particles (B) with the epoxy resin (A) and then distilling off the organic solvent.

The epoxy resin (A) may be liquid at 23° C., in order to facilitate the third step. “The epoxy resin (A) is liquid at 23° C.” means that the epoxy resin (A) has a softening point of not higher than 23° C., and that the epoxy resin (A) exhibits flowability at 23° C.

The present composition can be obtained by mixing, with a dispersion in which the polymer particles (B) are dispersed in the form of primary particles in the epoxy resin (A) (as obtained through the above first to third steps), the component (C) and the component (D) and, if necessary, an additional epoxy resin (A), the component (E), the component (F), the inorganic filler, the calcium oxide, and the other component(s). Further, according to such a production method, it is possible to obtain the present composition in a state in which the polymer particles (B) are dispersed in the form of primary particles. In a case where the present composition is a composition in which the polymer particles (B) are dispersed in the form of primary particles in the epoxy resin (A), there is an advantage in that a resulting cured product has excellent impact-peel-resistant adhesive strength.

A method for producing a one-component type thermosetting resin composition in one or more embodiments of the present invention includes a step of mixing all of the components, except for the amine adduct curing agent (D), of the one-component type thermosetting resin composition and then finally mixing the amine adduct curing agent (D). For example, a one-component type thermosetting resin composition may be obtained by (i) mixing, with a dispersion in which the polymer particles (B) are dispersed in the form of primary particles in the epoxy resin (A) (as obtained through the above first to third steps), the component (C) and, if necessary, an additional epoxy resin (A), the component (E), the component (F), the inorganic filler, the calcium oxide, and the other component(s) and then (ii) finally mixing the resulting mixture and the component (D). The temperature of a structural adhesive agent having high viscosity is easily increased due to shear heat during mixing in a production process with use of a mixer. Therefore, finally mixing the amine adduct curing agent (D) having a low softening temperature makes it possible to minimize the shear heat during mixing and, as a result, tends to improve storage stability.

Examples of a method for producing the one-component type thermosetting resin composition that satisfies the item (1) (that is, the composition (I)) and a method for producing the one-component type thermosetting resin composition that satisfies both the item (1) and the item (3) (that is, the composition (I)+(III)) encompass a production method including: a step of mixing the component (A), the component (B), the component (C), and the component (E) to obtain a mixture; and a step of mixing the obtained mixture and the component (D). Examples of a method for producing the one-component type thermosetting resin composition that satisfies the item (2) (that is, the composition (II)) and a method for producing the one-component type thermosetting resin composition that satisfies both the item (2) and the item (3) (that is, the composition (II)+(III)) encompass a production method including: a step of mixing the component (A), the component (B), the component (C), and the component (F) to obtain a mixture; and a step of mixing the obtained mixture and the component (D). Examples of a method for producing the one-component type thermosetting resin composition that satisfies the item (3) (that is, the composition (III)) encompass a production method including: a step of mixing the component (A), the component (B), the component (C), and the component (F) to obtain a mixture; and a step of mixing the obtained mixture and the component (D). Examples of a method for producing the one-component type thermosetting resin composition that satisfies both the item (1) and the item (2) (that is, the composition (I)+(II)) and a method for producing the one-component type thermosetting resin composition that satisfies all of the items (1), (2), and (3) (that is, the composition (I)+(II)+(III)) encompass a production method including: a step of mixing the component (A), the component (B), the component (C), the component (E), and the component (F) to obtain a mixture; and a step of mixing the obtained mixture and the component (D).

### [Cured Product]

In one or more embodiments of the present invention, a cured product obtained by curing the present composition is provided. In the present specification, the “cured product in accordance with one or more embodiments of the present invention” may be referred to as “the present cured product”.

The present cured product has the above-described configuration and thus has an advantage of having excellent adhesive strength.

### [Others]

### <Application Method>

The present composition can be applied to a base material by a discretionarily chosen method. According to a suitable embodiment, it is possible to apply the present composition at a low temperature of about room temperature, and it is also possible to heat the present composition as necessary and then apply the present composition. The present composition is particularly useful for a method of performing heating and then performing application because the present composition has excellent storage stability.

Bonding between two base materials is achieved by applying the present composition to one or both of the two base materials, bringing the two base materials to be bonded into contact with each other such that the present composition is disposed between the two base materials, and then curing the present composition in that state.

In a case where the present curable resin composition is used as a structural adhesive agent for bonding structural members of a vehicle or the like, it is possible to reinforce the bonding by performing spot welding as appropriate after the application of the curable resin composition as a weldbonding method.

### <Adhesive Agent>

In one or more embodiments of the present invention, an adhesive agent containing the present composition is provided. The adhesive agent containing the present composition has an advantage of making it possible to provide a cured product (adhesive layer) having excellent adhesive strength by low-temperature curing and an advantage of having excellent storage stability. In a case where the present composition is used as an adhesive agent to bond various base materials together, it is possible to bond base materials made of, for example, wood, metal, plastic, and glass, and the like. Especially, bonding automotive parts is preferable, and bonding automotive frames together or bonding an automotive frame to another automotive part is more preferable. Examples of the base materials encompass: steel materials such as cold-rolled steel and hot-dip galvanized steel; aluminum materials such as aluminum and coated aluminum; and various plastic-based substrates such as general-purpose plastic, engineering plastic, and composites such as CFRP and GFRP. The present curable resin composition may be used alone as an adhesive agent, and, if necessary, may be used as an adhesive agent obtained by mixing the present composition and other components.

The present composition can be suitably utilized as a structural adhesive agent for weldbonding because a cured product obtained by curing the present composition has excellent adhesive strength. That is, in one or more embodiments of the present invention, a structural adhesive agent for weldbonding containing the present composition is provided.

Bonding two base materials with the present cured product interposed therebetween is achieved by applying an adhesive agent containing the present composition to one or both of the two base materials, bringing the two base materials into contact with each other such that the adhesive agent containing the present composition is disposed between the two base materials, and then curing the present composition in that state. That is, in one or more embodiments of the present invention, provided is a laminate including: at least two base materials; and an adhesive agent or an adhesive layer for bonding the at least two base materials, the adhesive agent containing the present composition, the adhesive layer being obtained by curing an adhesive agent for weldbonding containing the present composition.

A laminate in accordance with one or more embodiments of the present invention can also be expressed as follows:

A laminate including: a first base material; an adhesive agent containing the present composition or a cured product obtained by curing an adhesive agent for weldbonding containing the present composition; and a second base material, the first base material, the adhesive agent or the cured product, and the second base material being stacked in this order.

The present composition has excellent adhesive strength. Thus, a laminate in which a plurality of members including an aluminum base material are bonded together by sandwiching the present composition between the plurality of members and then curing the composition, has high adhesive strength and is therefore preferable.

In recent years, for weight reduction, an aluminum material tends to be frequently used as a base material for automotive parts. An aluminum material and a steel material have significantly different linear expansion coefficients. In general, there may be a case in which bonding different types of base materials having significantly different linear expansion coefficients together with an adhesive agent greatly distorts a bonding portion at the time of decreasing the temperature of the adhesive agent to room temperature after the adhesive agent has been cured at a high temperature (for example, 170° C. to 190° C.). The present composition can be cured at a low temperature (for example, 120° C. to 140° C.) and has excellent toughness. Therefore, as described above, even when different types of base materials having different linear expansion coefficients are bonded together with use of an adhesive agent containing the present composition or an adhesive agent for weldbonding containing the present composition, the present composition has an advantage of making it possible to remedy the distortion of the bonding portion. In other words, the at least two base materials may be at least two base materials having different linear expansion coefficients (for example, having a difference of not less than 5×10⁻⁶/° C.).

Further, the curable resin composition in accordance with one or more embodiments of the present invention can also be used for bonding of aerospace components, particularly exterior metal components.

### <Curing Temperature>

A curing temperature of the present composition (for example, a curing temperature of the composition used when the laminate is produced) is not particularly limited, provided that the curing temperature is not lower than 100° C., and may be 115° C. to 145° C., 117° C. to 140° C., 118° C. to 135° C., or 120° C. to 130° C.

A curing time of the present composition (for example, a curing time of the composition used when the laminate is produced) may be 10 minutes to 60 minutes, 12 minutes to 40 minutes, 13 minutes to 30 minutes, or 15 minutes to 25 minutes.

In other words, a method for producing a laminate in accordance with one or more embodiments of the present invention may include a step of curing the one-component type thermosetting resin composition, the adhesive agent, or the adhesive agent for weldbonding under conditions that the curing temperature is 115° C. to 145° C., and the curing time is 10 minutes to 60 minutes.

A method for producing a laminate in accordance with one or more embodiments of the present invention may include, before the step of curing the one-component type thermosetting resin composition, the adhesive agent, or the adhesive agent for weldbonding, the following steps:
a step of applying the one-component type thermosetting resin composition, the adhesive agent, or the adhesive agent for weldbonding to one or both of two base materials; and
a step of bringing the two base materials into contact with each other such that the one-component type thermosetting resin composition, the adhesive agent, or the adhesive agent for weldbonding is disposed between the two base materials.

In a case where the present composition is used as an adhesive agent for automobiles, it is preferable to apply the adhesive agent to an automotive member, then apply a coating material for, for example, electrodeposition coating to the automotive member, and then cure the adhesive agent concurrently with baking/curing of the coating material, from the viewpoint of shortening and simplification of the process.

### <Use Application>

The present composition is used suitably in the following applications: adhesive agents for structures for vehicles and aircrafts; adhesive agents such as a structural adhesive agent for wind-power generation; paints; materials for lamination with glass fibers; materials for printed wiring boards; solder resists; interlayer insulating films; build-up materials; adhesive agents for FPCs; electrically insulating materials including sealing materials for electronic components such as semiconductors and LEDs; die-bonding materials; underfill materials; semiconductor packaging materials such as ACF, ACP, NCF, and NCP; and sealing materials for display devices and lighting devices such as liquid crystal panels, OLED lighting devices, and OLED displays. The present composition is useful as a structural adhesive agent for weldbonding in particular.

One or more embodiments of the present invention may be configured as follows.

<1> A one-component type thermosetting resin composition including: an epoxy resin (A); polymer particles (B) in an amount of 1 part by mass to 100 parts by mass with respect to 100 parts by mass of the epoxy resin (A), the polymer particles (B) having a core-shell structure which includes a core layer and a shell layer; dicyandiamide (C) in an amount of 3.5 parts by mass to 19.0 parts by mass with respect to 100 parts by mass of the epoxy resin (A); and an amine adduct curing agent (D) in an amount of 0.3 parts by mass to 10.0 parts by mass with respect to 100 parts by mass of the epoxy resin (A), the amine adduct curing agent (D) being solid at room temperature, wherein
the one-component type thermosetting resin composition has an exothermic onset temperature of not lower than 80° C. and an exothermic peak temperature of not higher than 150° C. in a DSC curve of the one-component type thermosetting resin composition as measured with use of a differential scanning calorimeter under a condition that a temperature increase rate is 10° C./min, and
the one-component type thermosetting resin composition satisfies at least one selected from the group consisting of the following items (1) to (3):
(1) the one-component type thermosetting resin composition further comprises, in an amount of 0.5 parts by mass to 15.0 parts by mass, a urea compound (E) represented by general formula (X):

R¹—NH—C(═O)—N—R²₂ (X)
where R¹ is a substituted or unsubstituted hydrocarbon group having 1 to 20 carbon atoms, and two R² are each independently a substituted or unsubstituted hydrocarbon group having 1 to 20 carbon atoms,
a ratio (Wc/We) of a total mass Wc of the dicyandiamide (C) to a total mass We of the urea compound (E) is 1.1 to 20.0, and
a ratio (We/Wd) of the total mass We of the urea compound (E) to a total mass Wd of the amine adduct curing agent (D) is 1.1 to 20.0;
(2) the one-component type thermosetting resin composition further comprises an epoxy-based reactive diluent (F) in an amount of 1.0 part by mass to 20.0 parts by mass; and
(3) the shell layer of the polymer particles (B) has an epoxy group, and a contained amount of the epoxy group in the shell layer with respect to a total mass of the shell layer is more than 0 mmol/g and not more than 2.0 mmol/g.

<2> The one-component type thermosetting resin composition described in <1>, wherein the one-component type thermosetting resin composition satisfies the item (1) and/or the item (2), and, in addition, the shell layer of the polymer particles (B) has an epoxy group, and a contained amount of the epoxy group in the shell layer with respect to a total mass of the shell layer is more than 0 mmol/g and not more than 2.0 mmol/g.

<3> The one-component type thermosetting resin composition described in <1>, wherein the one-component type thermosetting resin composition satisfies the item (1) and/or the item (2), and, in addition, the shell layer of the polymer particles (B) does not have an epoxy group.

<4> The one-component type thermosetting resin composition described in any one of <1> to <3>, wherein the one-component type thermosetting resin composition satisfies the item (1) and further comprises the epoxy-based reactive diluent (F) in an amount of 1.0 part by mass to 20.0 parts by mass.

<5> The one-component type thermosetting resin composition described in any one of <1> to <4>, wherein the epoxy resin (A) contains bisphenol A epoxy resin and/or bisphenol F epoxy resin.

<6> The one-component type thermosetting resin composition described in any one of <1> to <5>, wherein the core layer contains at least one type selected from the group consisting of diene-based rubbers, (meth)acrylate-based rubbers, and organosiloxane-based rubbers.

<7> The one-component type thermosetting resin composition described in any one of <1> to <6>, wherein the core layer is butadiene rubber and/or butadiene-styrene rubber.

<8> The one-component type thermosetting resin composition described in any one of <1> to <7>, wherein the shell layer contains a structural unit derived from at least one type of monomer selected from the group consisting of aromatic vinyl-based monomers, vinyl cyanide-based monomers, and (meth)acrylate-based monomers.

<9> The one-component type thermosetting resin composition described in any one of <1> to <8>, wherein the amine adduct curing agent (D) contains at least one type selected from the group consisting of amine-epoxy adduct curing agents and urea adduct curing agents.

<10> The one-component type thermosetting resin composition described in any one of <1> to <9>, wherein the epoxy-based reactive diluent (F) contains an epoxy-based reactive diluent having one epoxy group in one molecule.

<11> The one-component type thermosetting resin composition described in any one of <1> to <10>, wherein the amine adduct curing agent (D) contains an amine adduct curing agent having a softening temperature of 80° C. to 140° C.

<12> The one-component type thermosetting resin composition described in any one of <1> to <11>, wherein the urea compound (E) contains 3-(3,4-dichlorophenyl)-1,1-dimethylurea and/or 3,3′-[methylenebis(4,1-phenylene)]bis(1,1-dimethylurea).

<13> A cured product obtained by curing the one-component type thermosetting resin composition described in any one of <1> to <12>.

<14> An adhesive agent including the one-component type thermosetting resin composition described in any one of <1> to <12>.

<15> An adhesive agent for weldbonding including the one-component type thermosetting resin composition described in any one of <1> to <12>.

<16> A laminate including: at least two base materials; and an adhesive layer that is for bonding the at least two base materials and that is obtained by curing the adhesive agent described in <14> or the adhesive agent for weldbonding described in <15>.

<17> The laminate described in <16>, wherein the at least two base materials are at least two base materials that have different linear expansion coefficients.

<18> A method for producing the laminate described in <16>, the method including a step of curing the one-component type thermosetting resin composition, the adhesive agent, or the adhesive agent for weldbonding under conditions that a curing temperature is 115° C. to 145° C., and a curing time is 10 minutes to 60 minutes.

<19> A method for producing the one-component type thermosetting resin composition described in any one of <1> to <12>, the method including a step of mixing all of components, except for the amine adduct curing agent (D), of the one-component type thermosetting resin composition and then finally mixing the amine adduct curing agent (D).

### EXAMPLES

The following description will discuss one or more embodiments of the present invention in detail with reference to Examples and Comparative Examples. Note that one or more embodiments of the present invention are not limited to these examples. One or more embodiments of the present invention can be achieved by altering the following Examples as appropriate within the scope of the gist disclosed herein. One or more embodiments of the present invention also include, in their technical scope, embodiments achieved by altering the following Examples as appropriate. Note that in the following Examples, Comparative Examples, and tables, “parts” means “parts by mass”, and “%” means “% by mass”.

### (Evaluation Methods)

First, the following description will discuss methods of evaluating one-pack type thermosetting resin compositions produced in the Examples and Comparative Examples.

### [Measurement of Volume-Average Particle Size]

The volume-average particle size (Mv) of polymer particles (B) dispersed in aqueous latex was measured with use of the Microtrac UPA150 (manufactured by Nikkiso Co., Ltd.). The sample used for measurement was prepared by diluting the aqueous latex in deionized water. For each production example, when making measurements, the refractive index of water and the refractive index of polymer particles (B) obtained in that production example were inputted, measurement time was set to 600 seconds, and the concentration of the sample was adjusted such that the signal level fell within a range of 0.6 to 0.8.

### [DSC Parameter]

The exothermic onset temperature and the exothermic peak temperature of the composition were measured by the following method. For 0.02 g of the composition used as a sample, differential scanning calorimetry was carried out by use of a differential scanning calorimeter (manufactured by Hitachi High-Tech Science Corporation; DSC7020) under the condition that a temperature increase rate was 10° C./min. The exothermic onset temperature and the exothermic peak temperature of the composition were calculated from an obtained DSC curve.

### [Measurement of Shear Adhesive Strength]

A method for measuring the shear adhesive strength of a cured product obtained by curing the composition was as follows. The composition was applied to two cold-rolled steel sheets (SPCC steel sheets) each having dimensions of 25 mm wide by 100 mm long by 1.6 mm thick, and the cold-rolled steel sheets were placed on top of each other so as to achieve an adhesive layer thickness of 0.25 mm. After that, the composition provided between the two cold-rolled steel sheets was cured under the conditions of 120° C. and 20 minutes to obtain a laminate. For the obtained laminate used as a sample, the shear adhesive strength (MPa) was measured by use of Autograph AG-2000E (manufactured by Shimadzu Corporation) in accordance with JIS K6850. As the measurement conditions, the measurement temperature was 23° C., and the test speed was 1.3 mm/min.

### [Measurement of T-Peel Adhesive Strength]

A method for measuring the T-peel adhesive strength of a cured product obtained by curing the composition was as follows. The composition was applied to two cold-rolled steel sheets (SPCC steel sheets) each having dimensions of 25 mm wide by 200 mm long by 0.5 mm thick, and the cold-rolled steel sheets were placed on top of each other so as to achieve an adhesive layer thickness of 0.25 mm. After that, the composition provided between the two cold-rolled steel sheets was cured under the conditions of 120° C. and 20 minutes to obtain a laminate. For the obtained laminate used as a sample, the T-peel adhesive strength (N/25 mm) was measured in accordance with JIS K6854. As the measurement conditions, the measurement temperature was 23° C., and the test speed was 254 mm/min.

### [Measurement of Dynamic Resistance to Cleavage (Impact-Peel-Resistant Adhesiveness)]

A method for measuring the shear adhesive strength of a cured product obtained by curing the composition was as follows. The composition was applied to two cold-rolled steel sheets (SPCC steel sheets) each having dimensions of 20 mm wide by 90 mm long by 0.8 mm thick, and the cold-rolled steel sheets were placed on top of each other so as to achieve an adhesive layer thickness of 0.25 mm. After that, the composition provided between the two cold-rolled steel sheets was cured under the conditions of 120° C. and 20 minutes to obtain a laminate. For the obtained laminate used as a sample, the dynamic resistance to cleavage (impact-peel-resistant adhesiveness) at 23° C. was measured in accordance with ISO 11343.

### [Measurement of Shear Rate Dependency of Viscosity (Workability)]

A method for measuring the shear rate dependency of the viscosity of the composition was as described in the following (i) and (ii). (i) The viscosity at 50° C. of the composition was measured at each of the shear rates of 1 s⁻¹ and 10 s⁻¹ with use of a rheometer. (ii) Then, a ratio of the viscosity of the composition at 1 s⁻¹ to the viscosity of the composition at 10 s⁻¹ (the viscosity of the composition at 1 s⁻¹/the viscosity of the composition at 10 s⁻¹) was calculated, and the obtained value was regarded as the shear rate dependency of the viscosity.

A larger value of the shear rate dependency of the viscosity (that is, the viscosity of the composition at 1 s⁻¹/the viscosity of the composition at 10 s⁻¹) means more excellent workability.

### [Measurement of Viscosity Increase Rate (Storage Stability)]

A method for measuring a viscosity increase rate of the composition was as described in the following (i) to (iv). (i) The viscosity at 50° C. of the composition was measured at the shear rate of 5 s⁻¹ with use of a rheometer. (ii) Then, the composition was left to stand (stored) at 40° C. for 14 days. (iii) After the composition had been left to stand, the viscosity at 50° C. of the composition was measured at a shear rate of 5 s⁻¹ with use of a rheometer. (iv) Next, a ratio of the viscosity of the composition after the composition was left to stand (stored) to the viscosity of the composition before the composition was left to stand (stored) (viscosity of the composition after storage/viscosity of the composition before storage) was calculated, and the obtained value was regarded as the viscosity increase rate.

### 1. Formation of Core Layer

### Production Example 1-1: Preparation of Polybutadiene Rubber Latex (R-1)

Into a 100 L pressure-resistant polymerization apparatus were introduced 200 parts by mass of deionized water, 0.03 parts by mass of tripotassium phosphate, 0.25 parts by mass of potassium dihydrogenphosphate, 0.002 parts by mass of disodium ethylenediaminetetraacetate (EDTA), 0.001 parts by mass of ferrous sulfate heptahydrate (FE), and 1.5 parts by mass of sodium dodecylbenzenesulfonate (SDS) as an emulsifying agent. Next, while the materials thus introduced were stirred, gas in the pressure-resistant polymerization apparatus was replaced with nitrogen, so as to sufficiently remove oxygen from the inside of the pressure-resistant polymerization apparatus. Thereafter, 100 parts by mass of butadiene (BD) was introduced into the pressure-resistant polymerization apparatus, and the temperature inside the pressure-resistant polymerization apparatus was raised to 45° C. Thereafter, 0.015 parts by mass of paramenthane hydroperoxide (PHP) was introduced into the pressure-resistant polymerization apparatus, and subsequently 0.04 parts by mass of sodium formaldehyde sulfoxylate (SFS) was introduced into the pressure-resistant polymerization apparatus, and polymerization was commenced. At the time 10 hours had elapsed from the start of polymerization, devolatilization was carried out under reduced pressure to remove the remaining monomer that was not used in polymerization, so as to end the polymerization. During the polymerization, PHP, EDTA, and FE were each added to the pressure-resistant polymerization apparatus in discretionarily selected amounts and discretionarily selected points in time. Through this polymerization was obtained a latex (R-1), which included a core layer (polybutadiene rubber particles) whose main component was polybutadiene rubber. The volume-average particle size of the polybutadiene rubber particles contained in the latex thus obtained was 0.10 μm.

### Production Example 1-2: Preparation of Polybutadiene Rubber Latex (R-2)

Into a 100 L pressure-resistant polymerization apparatus were introduced 21 parts by mass of the polybutadiene rubber latex (R-1) (including 7 parts by mass of polybutadiene rubber particles) obtained in Production Example 1-1, 200 parts by mass of deionized water, 0.03 parts by mass of tripotassium phosphate, 0.002 parts by mass of EDTA, and 0.001 parts by mass of FE. Next, while the materials thus introduced were stirred, gas in the pressure-resistant polymerization apparatus was replaced with nitrogen, so as to sufficiently remove oxygen from the inside of the pressure-resistant polymerization apparatus. Thereafter, 93 parts by mass of BD was introduced into the pressure-resistant polymerization apparatus, and the temperature inside the pressure-resistant polymerization apparatus was raised to 45° C. Thereafter, 0.02 parts by mass of PHP was introduced into the pressure-resistant polymerization apparatus, and subsequently 0.10 parts by mass of SFS was introduced into the pressure-resistant polymerization apparatus, and polymerization was commenced. At the time 30 hours had elapsed from the start of polymerization, devolatilization was carried out under reduced pressure to remove the remaining monomer that was not used in polymerization, so as to end the polymerization. During the polymerization, PHP, EDTA, and FE were each added to the pressure-resistant polymerization apparatus in discretionarily selected amounts and discretionarily selected points in time. Through this polymerization was obtained a latex (R-2), which included a core layer (polybutadiene rubber particles) whose main component was polybutadiene rubber. The volume-average particle size of the polybutadiene rubber particles contained in the latex thus obtained was 0.20 μm.

### 2. Preparation of Polymer Particles (B) (Formation of Shell Layer)

### Production Example 2-1: Preparation of Core-Shell Polymer Latex (L-1)

Into a glass reaction vessel were introduced 262 parts by mass of the polybutadiene rubber latex (R-2) prepared in Production Example 1-2 (including 87 parts by mass of polybutadiene rubber particles) and 57 parts by mass of deionized water. Here, the glass reaction vessel had a thermometer, a stirrer, a reflux condenser, a nitrogen inlet, and a monomer adding device. The gas in the glass reaction vessel was replaced with nitrogen, and while doing so the materials in the glass reaction vessel were stirred at 60° C. Next, 0.004 parts by mass of EDTA, 0.001 parts by mass of FE, and 0.2 parts by mass of SFS were added into the glass reaction vessel. Thereafter, a mixture of (i) a monomer for shell layer formation (6 parts by mass of methyl acrylate (MA), 2.7 parts by mass of butyl acrylate (BA), and 4.3 parts by mass of glycidyl methacrylate (GMA)) and (ii) 0.04 parts by mass of cumene hydroperoxide (CHP) was added continuously into the glass reaction vessel over 120 minutes. Thereafter, 0.04 parts by mass of CHP was added into the glass reaction vessel, and the resulting mixture in the glass reaction vessel was stirred for 2 hours so as to finish polymerization. Via the above operations was obtained an aqueous latex (L-1) containing fine polymer particles (B) (core-shell polymer). The polymerization conversion ratio of the monomer component was not less than 99%. The volume-average particle size of the polymer particles (B) contained in the aqueous latex (L-1) thus obtained was 0.21 μm. A contained amount of an epoxy group with respect to the total mass of a shell layer in the polymer particles (B) was 2.3 mmol/g.

### Production Example 2-2: Preparation of Core-Shell Polymer Latex (L-2)

An aqueous latex (L-2) containing polymer particles (B) (core-shell polymer) was obtained via the same method used in Production Example 2-1, except that, as the monomer for shell layer formation, instead of using 6 parts by mass of MA, 2.7 parts by mass of BA, and 4.3 parts by mass of GMA, the following were used: 1 part by mass of methyl methacrylate (MMA), 6 parts by mass of styrene (ST), 2 parts by mass of acrylonitrile (AN), and 4 parts by mass of GMA. The volume-average particle size of the polymer particles (B) contained in the aqueous latex (L-2) thus obtained was 0.21 μm. A contained amount of an epoxy group with respect to the total mass of a shell layer in the polymer particles (B) was 2.2 mmol/g.

### Production Example 2-3: Preparation of Core-Shell Polymer Latex (L-3)

An aqueous latex (L-3) containing polymer particles (B) (core-shell polymer) was obtained via the same method used in Production Example 2-1, except that, as the monomer for shell layer formation, instead of using 6 parts by mass of MA, 2.7 parts by mass of BA, and 4.3 parts by mass of GMA, the following were used: 3 parts by mass of MMA, 6 parts by mass of ST, 2 parts by mass of AN, and 2 parts by mass of GMA. The volume-average particle size of the polymer particles (B) contained in the aqueous latex (L-3) thus obtained was 0.21 μm. A contained amount of an epoxy group with respect to the total mass of a shell layer in the polymer particles (B) was 1.1 mmol/g.

### Production Example 2-4: Preparation of Core-Shell Polymer Latex (L-4)

An aqueous latex (L-4) containing polymer particles (B) (core-shell polymer) was obtained via the same method used in Production Example 2-1, except that, as the monomer for shell layer formation, instead of using 6 parts by mass of MA, 2.7 parts by mass of BA, and 4.3 parts by mass of GMA, the following were used: 4 parts by mass of MMA, 6 parts by mass of ST, 2 parts by mass of AN, and 1 part by mass of GMA. The volume-average particle size of the polymer particles (B) contained in the aqueous latex (L-4) thus obtained was 0.21 μm. A contained amount of an epoxy group with respect to the total mass of a shell layer in the polymer particles (B) was 0.5 mmol/g.

### Production Example 2-5: Preparation of Core-Shell Polymer Latex (L-5)

An aqueous latex (L-5) containing polymer particles (B) (core-shell polymer) was obtained via the same method used in Production Example 2-1, except that, as the monomer for shell layer formation, instead of using 6 parts by mass of MA, 2.7 parts by mass of BA, and 4.3 parts by mass of GMA, the following were used: 5 parts by mass of MMA, 6 parts by mass of ST, and 2 parts by mass of AN. The volume-average particle size of the polymer particles (B) contained in the aqueous latex (L-5) thus obtained was 0.21 μm. A contained amount of an epoxy group with respect to the total mass of a shell layer in the polymer particles (B) was 0.0 mmol/g.

### 3. Preparation of Dispersion (M) in which Polymer Particles (B) are Dispersed in Curable Resin

### Production Examples 3-1 to 3-5: Preparation of Dispersions (M-1) to (M-5)

Into a 1 L mixing vessel at 25° C. was introduced 132 g of methyl ethyl ketone (MEK). Next, while the MEK was stirred, 132 g of the aqueous latex (equivalent to 40 g of polymer particles (B)) shown in Table 1 in each of Production Examples was introduced into the mixing vessel. After the materials in the mixing vessel had been mixed uniformly, 200 g of water was introduced into the mixing vessel at a feed rate of 80 g/min while the materials in the mixing vessel were stirred. After the water had been fed, the stirring was promptly stopped, and a slurry liquid was obtained, the slurry liquid being constituted by (i) an aggregate that contains polymer particles (B) and (ii) an aqueous phase that contains a small amount of organic solvent. The aggregate was buoyant. Next, 360 g of the aqueous phase was let out from an outlet in a lower part of the mixing vessel such that the aggregate containing a portion of the aqueous phase remained in the mixing vessel. To the aggregate thus obtained was added 90 g of MEK, and these were mixed uniformly so as to obtain a dispersion liquid in which the polymer particles (B) were dispersed uniformly in the MEK. To this dispersion liquid was added 60 g of an epoxy resin (A-1) (which is the component (A)), and these were mixed uniformly. The epoxy resin (A-1) will be described in detail below. The MEK was removed from the resulting mixture with use of a rotary evaporator. In this way, dispersions (M-1) to (M-5) in which the polymer particles (B) were dispersed in the epoxy resin (A) were obtained.

TABLE 1

| Production | | Aqueous |
|---|---|---|
| Example | Dispersion | latex |
| 3-1 | M-1 | L-1 |
| 3-2 | M-2 | L-2 |
| 3-3 | M-3 | L-3 |
| 3-4 | M-4 | L-4 |
| 3-5 | M-5 | L-5 |

### Examples 1 to 31 and Comparative Examples 1 to 14

According to the formulas (blends) shown in Tables 2 to 7, each of the components was weighed out, and the components were sufficiently mixed to obtain a one-component type thermosetting resin composition. Note that, in a case where the amine adduct curing agent (D) was contained, all of the components except for the component (D) were weighed out and mixed sufficiently, and then the component (D) was finally weighed out and sufficiently mixed to obtain a one-component type thermosetting resin composition. The shear adhesive strength of the obtained composition, the T-peel adhesive strength thereof, the dynamic resistance to cleavage (impact-peel-resistant adhesiveness), the shear rate dependency of the viscosity (workability) thereof, and the viscosity increase rate (storage stability) thereof were each measured by the above-described methods, and test results of those are shown in Tables 2 to 7.

The following agents were used as various blended agents indicated in Tables 2 to 7.

### <Epoxy Resin (A)>

A-1: JER828 (manufactured by Mitsubishi Chemical Corporation; bisphenol A epoxy resin (BisA epoxy resin) which is liquid at normal temperature; epoxy equivalent: 184 g/eq to 194 g/eq)
A-2: JER807 (manufactured by Mitsubishi Chemical Corporation; bisphenol F epoxy resin (BisF epoxy resin) which is liquid at normal temperature; epoxy equivalent: 160 g/eq to 175 g/eq)
A-3: HyPox RA1340 (manufactured by CVC; rubber-modified epoxy resin; epoxy equivalent: 350 g/eq)
   <Dispersion (M) in which Polymer Particles (B) are Dispersed in Epoxy resin (A)>
M-1 to M-5: Dispersions obtained in Production Examples 3-1 to 3-5

### <Dicyandiamide (C)>

Dyhard 100S (manufactured by AlzChem; dicyandiamide)

### <Amine Adduct Curing Agent (D)>

Ajicure PN-40 (manufactured by Ajinomoto Fine-Techno Co., Inc.; amine-epoxy adduct curing agent; softening temperature: 108° C.; particle size: 11.6 μm)
Ajicure PN-23 (manufactured by Ajinomoto Fine-Techno Co., Inc.; amine-epoxy adduct curing agent; softening temperature: 95° C.; particle size: 12.3 μm)
Ajicure PN-23J (manufactured by Ajinomoto Fine-Techno Co., Inc.; amine-epoxy adduct curing agent; softening temperature: 95° C.; particle size: 2.6 μm)
Ajicure PN-50 (manufactured by Ajinomoto Fine-Techno Co., Inc.; amine-epoxy adduct curing agent; softening temperature: 115° C.; particle size: 11.4 μm)
Ajicure PN-40J (manufactured by Ajinomoto Fine-Techno Co., Inc.; amine-epoxy adduct curing agent; softening temperature: 106° C.; particle size: 2.7 μm)

### <Urea Compound (E)>

Dyhard UR200 (manufactured by AlzChem; 3-(3,4-dichlorophenyl)-1,1-dimethylurea)
Omicure 52 (manufactured by Huntsman; 3,3′-[methylenebis(4,1-phenylene)]bis(1,1-dimethylurea))
Dyhard UR500 (manufactured by AlzChem; 1,1′-(4-methyl-1,3-phenylene)bis(3,3-dimethylurea))

### <<Modified Aliphatic Polyamine

Ancamine 2014AS (manufactured by Evonik)

### <Epoxy-Based Reactive Diluent (F)>

YED216M (manufactured by Mitsubishi Chemical Corporation, 1,6-hexanediol diglycidyl ether)
Cardura E10P (manufactured by Hexion; neodecanoic acid glycidyl ester)
ERISYS GE-10 (manufactured by Huntsman; o-cresyl glycidyl ether)
4-tert-butylphenyl glycidyl ether (manufactured by Tokyo Chemical Industry Co., Ltd.)

### <<Fumed Silica>>

CAB-O-SIL TS-720 (manufactured by CABOT; fumed silica surface-treated with polydimethylsiloxane) (denoted as “TS-720” in Tables)

### <<Calcium Carbonate>>

Whiton SB (manufactured by Shiraishi Calcium; non-treated ground calcium carbonate)

### <<Calcium Oxide>>

CML #31 (manufactured by Ohmi Chemical Industry; calcium oxide that has been surface-treated with fatty acid)

TABLE 2

| | | | | Example | | | | | |
|---|---|---|---|---|---|---|---|---|---|
| Composition (parts by mass) | | | | 1 | 2 | 3 | 4 | 5 | 6 |
| (A) | Epoxy resin | A-1 | | 32.5 | 32.5 | 32.5 | 32.5 | 32.5 | 32.5 |
| (A) + (B) | Dispersion (M) in | M-1 | 2.3 ⁽*⁾ | 112.5 | 112.5 | 112.5 | 112.5 | 112.5 | 112.5 |
| | which polymer | | | | | | | | |
| | particles (B) are | | | | | | | | |
| | dispersed in | | | | | | | | |
| | epoxy resin (A) | | | | | | | | |

| | | | | | | | | |
|---|---|---|---|---|---|---|---|---|
| (C) | Dicyandiamide | Dyhard 100S | 7 | 7 | 7 | 7 | 7 | 7 |
| (D) | Amine adduct | Ajicure PN-40 | 3 | 2 | 1.5 | 1 | 0.5 | |
| | curing agent | Ajicure PN-23 | | | | | | 1.5 |
| | | Ajicure PN-23J | | | | | | |
| | | Ajicure PN-50 | | | | | | |
| (E) | Urea compound | Dyhard UR200 | 5 | 5 | 5 | 5 | 5 | 5 |
| | | Omicure 52 | | | | | | |
| | | Dyhard UR500 | | | | | | |
| Others | Fumed silica | TS-720 | 6 | 6 | 6 | 6 | 6 | 6 |
| | Non-treated | Whiton SB | 60 | 60 | 60 | 60 | 60 | 60 |
| | ground calcium | | | | | | | |
| | carbonate | | | | | | | |
| | Calcium oxide | CML#31 | 1.5 | 1.5 | 1.5 | 1.5 | 1.5 | 1.5 |

| | Example | | | | | | | | | | | |
|---|---|---|---|---|---|---|---|---|---|---|---|---|
| | 1 | | 2 | | 3 | | 4 | | 5 | | 6 | |
| Type of one-component type | (I) | | (I) | | (I) | | (I) | | (I) | | (I) | |
| thermosetting resin composition | | | | | | | | | | | | |
| Amount of component (B) with respect to 100 | 45 | parts | 45 | parts | 45 | parts | 45 | parts | 45 | parts | 45 | parts |
| parts of component (A) (parts by mass) | | | | | | | | | | | | |
| Amount of component (C) with respect to 100 | 7 | parts | 7 | parts | 7 | parts | 7 | parts | 7 | parts | 7 | parts |
| parts of component (A) (parts by mass) | | | | | | | | | | | | |
| Amount of component (D) with respect to 100 | 3 | parts | 2 | parts | 1.5 | parts | 1 | part | 0.5 | parts | 1.5 | parts |
| parts of component (A) (parts by mass) | | | | | | | | | | | | |
| Amount of component (E) with respect to 100 | 5 | parts | 5 | parts | 5 | parts | 5 | parts | 5 | parts | 5 | parts |

| | | | | | | |
|---|---|---|---|---|---|---|
| parts of component (A) (parts by mass) | | | | | | |
| Ratio of total amount Wc of component (C) to | 1.4 | 1.4 | 1.4 | 1.4 | 1.4 | 1.4 |
| total amount We of component (E) (Wc/We) | | | | | | |
| Ratio of total amount We of component (E) to | 1.7 | 2.5 | 3.3 | 5.0 | 10.0 | 3.3 |
| total amount Wd of component (D) (We/Wd) | | | | | | |
| Exothermic onset temperature (° C.) | 92 | 99 | 104 | 108 | 113 | 93 |
| Exothermic peak temperature (° C.) | 138 | 141 | 143 | 146 | 148 | 143 |
| Shear adhesive strength (MPa) | 16 | 17 | 22 | 21 | 12 | 16 |
| Dynamic resistance to cleavage (kN/m) | 27 | 29 | 33 | 36 | 38 | 36 |
| Shear rate dependency of viscosity | 3.3 | 3.3 | 5.1 | 5.6 | 6.6 | 6.0 |
| Viscosity increase rate | 9.7 | 1.7 | 1.2 | 0.9 | 0.8 | 1.1 |
| (viscosity after storage/viscosity before storage) | | | | | | |

| | | | | Example | | | | | |
|---|---|---|---|---|---|---|---|---|---|
| Composition (parts by mass) | | | | 7 | 8 | 9 | 10 | 11 | 12 |
| (A) | Epoxy resin | A-1 | | 32.5 | 32.5 | 32.5 | 32.5 | 32.5 | 32.5 |
| (A) + (B) | Dispersion (M) in | M-1 | 2.3 ⁽*⁾ | 112.5 | 112.5 | 112.5 | 112.5 | 112.5 | 112.5 |
| | which polymer | | | | | | | | |
| | particles (B) are | | | | | | | | |
| | dispersed in | | | | | | | | |
| | epoxy resin (A) | | | | | | | | |

| | | | | | | | | |
|---|---|---|---|---|---|---|---|---|
| (C) | Dicyandiamide | Dyhard 100S | 7 | 7 | 7 | 7 | 7 | 7 |
| (D) | Amine adduct | Ajicure PN-40 | | | | 1.5 | 1.5 | |
| | curing agent | Ajicure PN-23 | 1 | 0.5 | | | | |
| | | Ajicure PN-23J | | | 1.5 | | | |
| | | Ajicure PN-50 | | | | | | 3 |
| (E) | Urea compound | Dyhard UR200 | 5 | 5 | 5 | | | 5 |
| | | Omicure 52 | | | | 5 | | |
| | | Dyhard UR500 | | | | | 2 | |
| Others | Fumed silica | TS-720 | 6 | 6 | 6 | 6 | 6 | 6 |
| | Non-treated | Whiton SB | 60 | 60 | 60 | 60 | 60 | 60 |
| | ground calcium | | | | | | | |
| | carbonate | | | | | | | |
| | Calcium oxide | CML#31 | 1.5 | 1.5 | 1.5 | 1.5 | 1.5 | 1.5 |

| | Example | | | | | | | | | | | |
|---|---|---|---|---|---|---|---|---|---|---|---|---|
| | 7 | | 8 | | 9 | | 10 | | 11 | | 12 | |
| Type of one-component type | (I) | | (I) | | (I) | | (I) | | (I) | | (I) | |
| thermosetting resin composition | | | | | | | | | | | | |
| Amount of component (B) with respect to 100 | 45 | parts | 45 | parts | 45 | parts | 45 | parts | 45 | parts | 45 | parts |
| parts of component (A) (parts by mass) | | | | | | | | | | | | |
| Amount of component (C) with respect to 100 | 7 | parts | 7 | parts | 7 | parts | 7 | parts | 7 | parts | 7 | parts |
| parts of component (A) (parts by mass) | | | | | | | | | | | | |
| Amount of component (D) with respect to 100 | 1 | part | 0.5 | parts | 1.5 | parts | 1.5 | parts | 1.5 | parts | 3 | parts |
| parts of component (A) (parts by mass) | | | | | | | | | | | | |
| Amount of component (E) with respect to 100 | 5 | parts | 5 | parts | 5 | parts | 5 | parts | 2 | parts | 5 | parts |

| parts of component (A) (parts by mass) | | | | | | |
|---|---|---|---|---|---|---|
| Ratio of total amount Wc of component (C) to | 1.4 | 1.4 | 1.4 | 1.4 | 3.5 | 1.4 |
| total amount We of component (E) (Wc/We) | | | | | | |
| Ratio of total amount We of component (E) to | 5.0 | 10.0 | 3.3 | 3.3 | 1.3 | 1.7 |
| total amount Wd of component (D) (We/Wd) | | | | | | |
| Exothermic onset temperature (° C.) | 105 | 110 | 96 | 105 | 101 | 98 |
| Exothermic peak temperature (° C.) | 145 | 147 | 142 | 142 | 142 | 140 |
| Shear adhesive strength (MPa) | 21 | 21 | 19 | 21 | 19 | 20 |
| Dynamic resistance to cleavage (kN/m) | 37 | 37 | 35 | 28 | 30 | 28 |
| Shear rate dependency of viscosity | 6.0 | 5.6 | 7.8 | 5.8 | 5.0 | 4.4 |
| Viscosity increase rate | 0.9 | 0.8 | 15.1 | 1.2 | 13.6 | 1.4 |
| (viscosity after storage/viscosity before storage) | | | | | | |

⁽*⁾ Contained amount of epoxy group with respect to total amount of shell layer of polymer particles (B) (mmol/g)

TABLE 3

| | | | | Comparative Example | | | |
|---|---|---|---|---|---|---|---|
| Composition (parts by mass) | | | | 1 | 2 | 3 | 4 |
| (A) | Epoxy resin | A-1 | | 32.5 | 32.5 | 32.5 | 32.5 |
| (A) + (B) | Dispersion (M) in | M-1 | 2.3 ⁽*⁾ | 112.5 | 112.5 | 112.5 | 112.5 |
| | which polymer | | | | | | |
| | particles (B) are | | | | | | |
| | dispersed in | | | | | | |
| | epoxy resin (A) | | | | | | |

| | | | | | | |
|---|---|---|---|---|---|---|
| (C) | Dicyandiamide | Dyhard 100S | 7 | 7 | 7 | 7 |
| (D) | Amine adduct | Ajicure PN-40 | | 0.2 | | 1.5 |
| | curing agent | Ajicure PN-23 | 12 | | | |
| | | Ajicure PN-23J | | | | |
| | | Ajicure PN-50 | | | | |
| (E) | Urea compound | Dyhard UR200 | 5 | 5 | 5 | |
| | | Omicure 52 | | | | |
| | | Dyhard UR500 | | | | 20 |
| Others | Fumed silica | TS-720 | 6 | 6 | 6 | 6 |
| | Non-treated | Whiton SB | 60 | 60 | 60 | 60 |
| | ground calcium | | | | | |
| | carbonate | | | | | |
| | Calcium oxide | CML#31 | 1.5 | 1.5 | 1.5 | 1.5 |

| | Comparative Example | | | | | | | |
|---|---|---|---|---|---|---|---|---|
| | 1 | | 2 | | 3 | | 4 | |
| Type of one-component type | — | | — | | — | | — | |
| thermosetting resin composition | | | | | | | | |
| Amount of component (B) with respect to 100 | 45 | parts | 45 | parts | 45 | parts | 45 | parts |
| parts of component (A) (parts by mass) | | | | | | | | |
| Amount of component (C) with respect to 100 | 7 | parts | 7 | parts | 7 | parts | 7 | parts |
| parts of component (A) (parts by mass) | | | | | | | | |
| Amount of component (D) with respect to 100 | 12 | parts | 0.2 | parts | 0 | parts | 1.5 | parts |
| parts of component (A) (parts by mass) | | | | | | | | |
| Amount of component (E) with respect to 100 | 5 | parts | 5 | parts | 5 | parts | 20 | parts |

| | | | | |
|---|---|---|---|---|
| parts of component (A) (parts by mass) | | | | |
| Ratio of total amount Wc of component (C) to | 1.4 | 1.4 | 1.4 | 0.4 |
| total amount We of component (E) (Wc/We) | | | | |
| Ratio of total amount We of component (E) to | 0.4 | 25.0 | — | 13.3 |
| total amount Wd of component (D) (We/Wd) | | | | |
| Exothermic onset temperature (° C.) | 77 | 117 | 126 | 105 |
| Exothermic peak temperature (° C.) | 128 | 151 | 155 | 137 |
| Shear adhesive strength (MPa) | 16 | 2 | 0 | 23 |
| Dynamic resistance to cleavage (kN/m) | 13 | 42 | 0 | 37 |
| Shear rate dependency of viscosity | 2.9 | 6.9 | 7.4 | 5.6 |
| Viscosity increase rate | Gelati- | 0.9 | 0.9 | Gelati- |
| (viscosity after storage/viscosity before storage) | nized | | | nized |

| | | | | Comparative Example | | |
|---|---|---|---|---|---|---|
| Composition (parts by mass) | | | | 5 | 6 | 7 |
| (A) | Epoxy resin | A-1 | | 32.5 | 32.5 | 100 |
| (A) + (B) | Dispersion (M) in | M-1 | 2.3 ⁽*⁾ | 112.5 | 112.5 | 0 |
| | which polymer | | | | | |
| | particles (B) are | | | | | |
| | dispersed in | | | | | |
| | epoxy resin (A) | | | | | |

| | | | | | |
|---|---|---|---|---|---|
| (C) | Dicyandiamide | Dyhard 100S | 7 | 7 | 7 |
| (D) | Amine adduct | Ajicure PN-40 | 1.5 | 1.5 | 1.5 |
| | curing agent | Ajicure PN-23 | | | |
| | | Ajicure PN-23J | | | |
| | | Ajicure PN-50 | | | |
| (E) | Urea compound | Dyhard UR200 | | | 5 |
| | | Omicure 52 | | | |
| | | Dyhard UR500 | 0.2 | | |
| Others | Fumed silica | TS-720 | 6 | 6 | 6 |
| | Non-treated | Whiton SB | 60 | 60 | 60 |
| | ground calcium | | | | |
| | carbonate | | | | |
| | Calcium oxide | CML#31 | 1.5 | 1.5 | 1.5 |

| | Comparative Example | | | | | |
|---|---|---|---|---|---|---|
| | 5 | | 6 | | 7 | |
| Type of one-component type | — | | — | | — | |
| thermosetting resin composition | | | | | | |
| Amount of component (B) with respect to 100 | 45 | parts | 45 | parts | 0 | parts |
| parts of component (A) (parts by mass) | | | | | | |
| Amount of component (C) with respect to 100 | 7 | parts | 7 | parts | 7 | parts |
| parts of component (A) (parts by mass) | | | | | | |
| Amount of component (D) with respect to 100 | 1.5 | parts | 1.5 | parts | 1.5 | parts |
| parts of component (A) (parts by mass) | | | | | | |
| Amount of component (E) with respect to 100 | 0.2 | parts | 0 | parts | 5 | parts |

| | | | |
|---|---|---|---|
| parts of component (A) (parts by mass) | | | |
| Ratio of total amount Wc of component (C) to | 35.0 | — | 1.4 |
| total amount We of component (E) (Wc/We) | | | |
| Ratio of total amount We of component (E) to | 0.1 | 0.0 | 3.3 |
| total amount Wd of component (D) (We/Wd) | | | |
| Exothermic onset temperature (° C.) | 104 | 104 | 105 |
| Exothermic peak temperature (° C.) | 151 | 155 | 144 |
| Shear adhesive strength (MPa) | 4 | 0 | 10 |
| Dynamic resistance to cleavage (kN/m) | 0 | 0 | 0 |
| Shear rate dependency of viscosity | 5.8 | 6.4 | 5.7 |
| Viscosity increase rate | 1.0 | 1.6 | 1.1 |
| (viscosity after storage/viscosity before storage) | | | |

⁽*⁾ Contained amount of epoxy group with respect to total amount of shell layer of polymer particles (B) (mmol/g)

TABLE 4

| | | | | Example | | | | |
|---|---|---|---|---|---|---|---|---|
| Composition (parts by mass) | | | | 13 | 14 | 15 | 16 | 17 |
| (A | BisA epoxy resin | A-1 | | 32.5 | 32.5 | 32.5 | 32.5 | 32.5 |
| | BisF epoxy resin | A-2 | | | | | | |
| (A) + (B) | Dispersion (M) in | M-1 | 2.3 ⁽*⁾ | 112.5 | 112.5 | 112.5 | 112.5 | 112.5 |
| | which polymer | | | | | | | |
| | particles (B) are | | | | | | | |
| | dispersed in | | | | | | | |
| | epoxy resin (A) | | | | | | | |

| | | | | | | | |
|---|---|---|---|---|---|---|---|
| (C) | Dicyandiamide | Dyhard 100S | 7 | 7 | 7 | 7 | 7 |
| (D) | Amine adduct | Ajicure PN-40J | 5 | 5 | 5 | 5 | |
| | curing agent | Ajicure PN-40 | | | | | 1.5 |
| (E) | Urea compound | Dyhard UR200 | | | | | 5 |
| (F) | Epoxy-based | YED216M | 1.0 | | | | 1.0 |
| | reactive diluent | Cardura E10P | | 10 | | | |
| | | ERISYS GE-10 | | | 10 | | |
| | | p-tert-butylphenyl | | | | 10 | |
| | | glycidyl ether | | | | | |
| Others | Fumed silica | TS-720 | 6 | 6 | 6 | 6 | 6 |
| | Non-treated | Whiton SB | 60 | 60 | 60 | 60 | 60 |
| | ground calcium | | | | | | |
| | carbonate | | | | | | |
| | Calcium oxide | CML#31 | 1.5 | 1.5 | 1.5 | 1.5 | 1.5 |

| | Example | | | | | | | | | |
|---|---|---|---|---|---|---|---|---|---|---|
| | 13 | | 14 | | 15 | | 16 | | 17 | |
| Type of one-component type | (II) | | (II) | | (II) | | (II) | | (I) + (II) | |
| thermosetting resin composition | | | | | | | | | | |
| Amount of component (B) with respect to 100 | 45 | parts | 45 | parts | 45 | parts | 45 | parts | 45 | parts |
| parts of component (A) (parts by mass) | | | | | | | | | | |
| Amount of component (C) with respect to 100 | 7 | parts | 7 | parts | 7 | parts | 7 | parts | 7 | parts |
| parts of component (A) (parts by mass) | | | | | | | | | | |
| Amount of component (D) with respect to 100 | 5 | parts | 5 | parts | 5 | parts | 5 | parts | 2 | parts |
| parts of component (A) (parts by mass) | | | | | | | | | | |
| Amount of component (E) with respect to 100 | 0 | parts | 0 | parts | 0 | parts | 0 | parts | 5 | parts |
| parts of component (A) (parts by mass) | | | | | | | | | | |
| Amount of component (F) with respect to 100 | 10 | parts | 10 | parts | 10 | parts | 10 | parts | 10 | parts |

| | | | | | |
|---|---|---|---|---|---|
| parts of component (A) (parts by mass) | | | | | |
| Exothermic onset temperature (° C.) | 86 | 91 | 88 | 91 | 99 |
| Exothermic peak temperature (° C.) | 134 | 137 | 136 | 136 | 142 |
| Shear adhesive strength (MPa) | 15 | 16 | 13 | 15 | 20 |
| Dynamic resistance to cleavage (kN/m) | 29 | 31 | 31 | 31 | 40 |
| Shear rate dependency of viscosity | 2.7 | 2.4 | 2.6 | 2.5 | 4.0 |
| Viscosity increase rate | 3.2 | 2.4 | 2.5 | 2.8 | 1.0 |
| (viscosity after storage/viscosity before storage) | | | | | |

| | Comparative |
|---|---|
| Example | Example |

| Composition (parts by mass) | | | 18 | 19 | 8 | 9 |
|---|---|---|---|---|---|---|
| (A) | BisA epoxy resin | A-1 | 32.5 | 32.5 | 42.5 | 32.5 |
| | BisF epoxy resin | A-2 | | | | 10 |

| | | | | | | | |
|---|---|---|---|---|---|---|---|
| (A) + (B) | Dispersion (M) in | M-1 | 2.3 ⁽*⁾ | 112.5 | 112.5 | 112.5 | 112.5 |
| | which polymer | | | | | | |
| | particles (B) are | | | | | | |
| | dispersed in | | | | | | |
| | epoxy resin (A) | | | | | | |

| | | | | | | |
|---|---|---|---|---|---|---|
| (C) | Dicyandiamide | Dyhard 100S | 7 | 7 | 7 | 7 |
| (D) | Amine adduct | Ajicure PN-40J | | | 5 | 5 |
| | curing agent | Ajicure PN-40 | 1.5 | 1.5 | | |
| (E) | Urea compound | Dyhard UR200 | 5 | 5 | | |
| (F) | Epoxy-based | YED216M | | | | |
| | reactive diluent | Cardura E10P | 10 | | | |
| | | ERISYS GE-10 | | 10 | | |
| | | p-tert-butylphenyl | | | | |
| | | glycidyl ether | | | | |
| Others | Fumed silica | TS-720 | 6 | 6 | 6 | 6 |
| | Non-treated | Whiton SB | 60 | 60 | 60 | 60 |
| | ground calcium | | | | | |
| | carbonate | | | | | |
| | Calcium oxide | CML#31 | 1.5 | 1.5 | 1.5 | 1.5 |

| | | | | | Comparative | | | |
|---|---|---|---|---|---|---|---|---|
| | Example | | | | Example | | | |
| | 18 | | 19 | | 8 | | 9 | |
| Type of one-component type | (I) + (II) | | (I) + (II) | | — | | — | |
| thermosetting resin composition | | | | | | | | |
| Amount of component (B) with respect to 100 | 45 | parts | 45 | parts | 41 | parts | 41 | parts |
| parts of component (A) (parts by mass) | | | | | | | | |
| Amount of component (C) with respect to 100 | 7 | parts | 7 | parts | 6 | parts | 6 | parts |
| parts of component (A) (parts by mass) | | | | | | | | |
| Amount of component (D) with respect to 100 | 2 | parts | 2 | parts | 5 | parts | 5 | parts |
| parts of component (A) (parts by mass) | | | | | | | | |
| Amount of component (E) with respect to 100 | 5 | parts | 5 | parts | 0 | parts | 0 | parts |
| parts of component (A) (parts by mass) | | | | | | | | |
| Amount of component (F) with respect to 100 | 10 | parts | 10 | parts | 0 | parts | 0 | parts |

| | | | | |
|---|---|---|---|---|
| parts of component (A) (parts by mass) | | | | |
| Exothermic onset temperature (° C.) | 102 | 101 | 92 | 93 |
| Exothermic peak temperature (° C.) | 144 | 143 | 136 | 135 |
| Shear adhesive strength (MPa) | 20 | 22 | 4 | 2 |
| Dynamic resistance to cleavage (kN/m) | 38 | 38 | 25 | 28 |
| Shear rate dependency of viscosity | 4.2 | 4.9 | 2.0 | 2.2 |
| Viscosity increase rate | 0.9 | 0.8 | 3.2 | 3.3 |
| (viscosity after storage/viscosity before storage) | | | | |

⁽*⁾ Contained amount of epoxy group with respect to total amount of shell layer of polymer particles (B) (mmol/g)

TABLE 5

| | | | | Example | | | | |
|---|---|---|---|---|---|---|---|---|
| Composition (parts by mass) | | | | 20 | 21 | 22 | 23 | 24 |
| (A) | BisA epoxy resin | A-1 | | 32.5 | 32.5 | 32.5 | 32.5 | 32.5 |
| | Rubber-modified | A-3 | | | | | | 10 |
| | epoxy | | | | | | | |
| (A) + (B) | Dispersion (M) in | M-1 | 2.3 ⁽*⁾ | 112.5 | 112.5 | 112.5 | 112.5 | 112.5 |
| | which polymer | | | | | | | |
| | particles (B) are | | | | | | | |
| | dispersed in | | | | | | | |
| | epoxy resin (A) | | | | | | | |

| | | | | | | | |
|---|---|---|---|---|---|---|---|
| (C) | Dicyandiamide | Dyhard 100S | 7 | 7 | 7 | 7 | 7 |
| (D) | Amine adduct | Ajicure PN-40 | 5 | 5 | 5 | | |
| | curing agent | Ajicure PN-50 | | | | 5 | 5 |
| (E) | Urea compound | Dyhard UR500 | | | | | |
| | | Omicure 52 | | | | | |
| | Modified aliphatic | ANCAMINE | | | | | |
| | polyamine | 2014AS | | | | | |
| (F) | Epoxy-based | Cardura E10P | 10 | 10 | 10 | 10 | 10 |
| | reactive diluent | | | | | | |
| Others | Fumed silica | TS-720 | 6 | 6 | 6 | 6 | 6 |
| | Non-treated | Whiton SB | 60 | 0 | 100 | 60 | 60 |
| | ground calcium | | | | | | |
| | carbonate | | | | | | |
| | Calcium oxide | CML#31 | 1.5 | 1.5 | 1.5 | 1.5 | 1.5 |

| | Example | | | | | | | | | |
|---|---|---|---|---|---|---|---|---|---|---|
| | 20 | | 21 | | 22 | | 23 | | 24 | |
| Type of one-component type | (II) | | (II) | | (II) | | (II) | | (II) | |
| thermosetting resin composition | | | | | | | | | | |
| Amount of component (B) with respect to 100 | 45 | parts | 45 | parts | 45 | parts | 45 | parts | 41 | parts |
| parts of component (A) (parts by mass) | | | | | | | | | | |
| Amount of component (C) with respect to 100 | 7 | parts | 7 | parts | 7 | parts | 7 | parts | 6 | parts |
| parts of component (A) (parts by mass) | | | | | | | | | | |
| Amount of component (D) with respect to 100 | 5 | parts | 5 | parts | 5 | parts | 5 | parts | 5 | parts |
| parts of component (A) (parts by mass) | | | | | | | | | | |
| Amount of component (E) with respect to 100 | 0 | parts | 0 | parts | 0 | parts | 0 | parts | 0 | parts |
| parts of component (A) (parts by mass) | | | | | | | | | | |
| Amount of component (F) with respect to 100 | 10 | parts | 10 | parts | 10 | parts | 10 | parts | 9 | parts |

| | | | | | |
|---|---|---|---|---|---|
| parts of component (A) (parts by mass) | | | | | |
| Exothermic onset temperature (° C.) | 93 | 94 | 95 | 95 | 95 |
| Exothermic peak temperature (° C.) | 139 | 140 | 140 | 142 | 143 |
| Shear adhesive strength (MPa) | 15 | 18 | 14 | 7 | 11 |
| Dynamic resistance to cleavage (kN/m) | 16 | 28 | 17 | 15 | 20 |
| Shear rate dependency of viscosity | 3.0 | 4.4 | 3.0 | 3.0 | 3.2 |
| Viscosity increase rate | 1.0 | 1.3 | 1.8 | 1.0 | 1.1 |
| (viscosity after storage/viscosity before storage) | | | | | |

| | | | | Comparative Example | | |
|---|---|---|---|---|---|---|
| Composition (parts by mass) | | | | 10 | 11 | 12 |
| (A) | BisA epoxy resin | A-1 | | 32.5 | 32.5 | 32.5 |
| | Rubber-modified | A-3 | | | | |
| | epoxy | | | | | |
| (A) + (B) | Dispersion (M) in | M-1 | 2.3 ⁽*⁾ | 112.5 | 112.5 | 112.5 |
| | which polymer | | | | | |
| | particles (B) are | | | | | |
| | dispersed in | | | | | |
| | epoxy resin (A) | | | | | |

| | | | | | |
|---|---|---|---|---|---|
| (C) | Dicyandiamide | Dyhard 100S | 7 | 7 | 7 |
| (D) | Amine adduct | Ajicure PN-40 | | | |
| | curing agent | Ajicure PN-50 | | | |
| (E) | Urea compound | Dyhard UR500 | 5 | | |
| | | Omicure 52 | | 5 | |
| | Modified aliphatic | ANCAMINE | | | 5 |
| | polyamine | 2014AS | | | |
| (F) | Epoxy-based | Cardura E10P | 10 | 10 | 10 |
| | reactive diluent | | | | |
| Others | Fumed silica | TS-720 | 6 | 6 | 6 |
| | Non-treated | Whiton SB | 60 | 60 | 60 |
| | ground calcium | | | | |
| | carbonate | | | | |
| | Calcium oxide | CML#31 | 1.5 | 1.5 | 1.5 |

| Comparative Example | | | |
|---|---|---|---|
| | 10 | 11 | 12 |

| | | | |
|---|---|---|---|
| Type of one-component type | — | — | — |
| thermosetting resin composition | | | |

| | | | | | | |
|---|---|---|---|---|---|---|
| Amount of component (B) with respect to 100 | 45 | parts | 45 | parts | 45 | parts |
| parts of component (A) (parts by mass) | | | | | | |
| Amount of component (C) with respect to 100 | 7 | parts | 7 | parts | 7 | parts |
| parts of component (A) (parts by mass) | | | | | | |
| Amount of component (D) with respect to 100 | 0 | parts | 0 | parts | 0 | parts |
| parts of component (A) (parts by mass) | | | | | | |
| Amount of component (E) with respect to 100 | 5 | parts | 5 | parts | 0 | parts |
| parts of component (A) (parts by mass) | | | | | | |
| Amount of component (F) with respect to 100 | 10 | parts | 10 | parts | 10 | parts |

| | | | |
|---|---|---|---|
| parts of component (A) (parts by mass) | | | |
| Exothermic onset temperature (° C.) | 116 | 128 | 90 |
| Exothermic peak temperature (° C.) | 146 | 153 | 154 |
| Shear adhesive strength (MPa) | 19 | 0 | 0 |
| Dynamic resistance to cleavage (kN/m) | 37 | 0 | 0 |
| Shear rate dependency of viscosity | 4.2 | 6.2 | 2.6 |
| Viscosity increase rate | Gelati- | 0.7 | 4.9 |
| (viscosity after storage/viscosity before storage) | nized | | |

⁽*⁾ Contained amount of epoxy group with respect to total amount of shell layer of polymer particles (B) (mmol/g)

TABLE 6

| | | | | | | Comparative | |
|---|---|---|---|---|---|---|---|
| | | | | Example | | Example | |
| Composition (parts by mass) | | | | 25 | 26 | 13 | 14 |
| (A) | Epoxy resin | A-1 | | 42.5 | 42.5 | 42.5 | 42.5 |
| (A) + (B) | Dispersion (M) in | M-2 | 2.2 ⁽*⁾ | | | 112.5 | |
| | which polymer | M-3 | 1.1 ⁽*⁾ | 112.5 | | | |
| | particles (B) are | M-4 | 0.5 ⁽*⁾ | | 112.5 | | |
| | dispersed in | M-5 | 0 ⁽*⁾ | | | | 112.5 |
| | epoxy resin (A) | | | | | | |

| | | | | | | |
|---|---|---|---|---|---|---|
| (C) | Dicyandiamide | Dyhard 100S | 7 | 7 | 7 | 7 |
| (D) | Amine adduct | Ajicure PN-40 | 5 | 5 | 5 | 5 |
| | curing agent | | | | | |
| Others | Fumed silica | TS-720 | 6 | 6 | 6 | 6 |
| | Non-treated | Whiton SB | 60 | 60 | 60 | 60 |
| | ground calcium | | | | | |
| | carbonate | | | | | |
| | Calcium oxide | CML#31 | 1.5 | 1.5 | 1.5 | 1.5 |

| | | | | | Comparative | | | |
|---|---|---|---|---|---|---|---|---|
| | Example | | | | Example | | | |
| | 25 | | 26 | | 13 | | 14 | |
| Type of one-component type | (III) | | (III) | | — | | — | |
| thermosetting resin composition | | | | | | | | |
| Amount of component (B) with respect to 100 | 41 | parts | 41 | parts | 41 | parts | 41 | parts |
| parts of component (A) (parts by mass) | | | | | | | | |
| Amount of component (C) with respect to 100 | 6 | parts | 6 | parts | 6 | parts | 6 | parts |
| parts of component (A) (parts by mass) | | | | | | | | |
| Amount of component (D) with respect to 100 | 5 | parts | 5 | parts | 5 | parts | 5 | parts |

| | | | | |
|---|---|---|---|---|
| parts of component (A) (parts by mass) | | | | |
| Exothermic onset temperature (° C.) | 96 | 93 | 94 | 95 |
| Exothermic peak temperature (° C.) | 139 | 139 | 139 | 139 |
| Shear adhesive strength (MPa) | 9 | 11 | 4 | 6 |
| Viscosity increase rate | 1.2 | 1.1 | 1.3 | 1.1 |
| (viscosity after storage/viscosity before storage) | | | | |

⁽*⁾ Contained amount of epoxy group with respect to total amount of shell layer of polymer particles (B) (mmol/g)

TABLE 7

| | | | | Example | | | | |
|---|---|---|---|---|---|---|---|---|
| Composition (parts by mass) | | | | 27 | 28 | 29 | 30 | 31 |
| (A) | Epoxy resin | A-1 | | 55 | 55 | 55 | 55 | 55 |
| (A) + (B) | Dispersion (M) in | M-2 | 2.2 ⁽*⁾ | 75 | | | | |
| | which polymer | M-3 | 1.1 ⁽*⁾ | | 75 | | | 75 |
| | particles (B) are | M-4 | 0.5 ⁽*⁾ | | | 75 | | |
| | dispersed in | M-5 | 0 ⁽*⁾ | | | | 75 | |
| | epoxy resin (A) | | | | | | | |

| | | | | | | | |
|---|---|---|---|---|---|---|---|
| (C) | Dicyandiamide | Dyhard 100S | 7 | 7 | 7 | 7 | 7 |
| (D) | Amine adduct | Ajicure PN-40 | 1.5 | 1.5 | 1.5 | 1.5 | 1.5 |
| | curing agent | | | | | | |
| (E) | Urea compound | Dyhard UR200 | 5 | 5 | 5 | 5 | 5 |
| (F) | Epoxy-based | ERISYS GE-10 | | | | | 10 |
| | reactive diluent | | | | | | |
| Others | Fumed silica | TS-720 | 6 | 6 | 6 | 6 | 6 |
| | Non-treated | Whiton SB | 60 | 60 | 60 | 60 | 60 |
| | ground calcium | | | | | | |
| | carbonate | | | | | | |
| | Calcium oxide | CML#31 | 1.5 | 1.5 | 1.5 | 1.5 | 1.5 |

| | Example | | | | | | | | | |
|---|---|---|---|---|---|---|---|---|---|---|
| | 27 | | 28 | | 29 | | 30 | | 31 | |
| Type of one-component type | (I) | | (I) + (III) | | (I) + (III) | | (I) | | (I) + (II) + | |
| thermosetting resin composition | | | | | | | | | (III) | |
| Amount of component (B) with respect to 100 | 30 | parts | 30 | parts | 30 | parts | 30 | parts | 30 | parts |
| parts of component (A) (parts by mass) | | | | | | | | | | |
| Amount of component (C) with respect to 100 | 7 | parts | 7 | parts | 7 | parts | 7 | parts | 7 | parts |
| parts of component (A) (parts by mass) | | | | | | | | | | |
| Amount of component (D) with respect to 100 | 1.5 | parts | 1.5 | parts | 1.5 | parts | 1.5 | parts | 1.5 | parts |
| parts of component (A) (parts by mass) | | | | | | | | | | |
| Amount of component (E) with respect to 100 | 5 | parts | 5 | parts | 5 | parts | 5 | parts | 5 | parts |
| parts of component (A) (parts by mass) | | | | | | | | | | |
| Amount of component (F) with respect to 100 | 0 | parts | 0 | parts | 0 | parts | 0 | parts | 10 | parts |

| | | | | | |
|---|---|---|---|---|---|
| parts of component (A) (parts by mass) | | | | | |
| Exothermic onset temperature (° C.) | 99 | 100 | 101 | 101 | 101 |
| Exothermic peak temperature (° C.) | 143 | 143 | 143 | 142 | 143 |
| Shear adhesive strength (MPa) | 20 | 21 | 19 | 14 | 21 |
| T-peel adhesive strength (N/25 mm) | 103 | 121 | 117 | 77 | 147 |
| Dynamic resistance to cleavage (kN/m) | 23 | 27 | 18 | 2 | 23 |
| Shear rate dependency of viscosity | 2.3 | 2.6 | 2.6 | 2.7 | 3.0 |
| Viscosity increase rate | 1.0 | 1.0 | 1.0 | 1.0 | 1.0 |
| (viscosity after storage/viscosity before storage) | | | | | |

⁽*⁾ Contained amount of epoxy group with respect to total amount of shell layer of polymer particles (B) (mmol/g)

According to one or more embodiments of the present invention, it is possible to provide a one-component type thermosetting resin composition that makes it possible to provide a cured product having excellent adhesive strength by low-temperature curing and that has excellent storage stability. Therefore, one or more embodiments of the present invention are suitably applicable as an adhesive agent and particularly as a structural adhesive agent for vehicles.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims

1. A one-component type thermosetting resin composition comprising:
an epoxy resin (A);
polymer particles (B) in an amount of 1 part by mass to 100 parts by mass with respect to 100 parts by mass of the epoxy resin (A), the polymer particles (B) having a core-shell structure which includes a core layer and a shell layer;
dicyandiamide (C) in an amount of 3.5 parts by mass to 19.0 parts by mass with respect to 100 parts by mass of the epoxy resin (A); and
an amine adduct curing agent (D) in an amount of 0.3 parts by mass to 10.0 parts by mass with respect to 100 parts by mass of the epoxy resin (A), the amine adduct curing agent (D) being solid at room temperature,
wherein:
the one-component type thermosetting resin composition has an exothermic onset temperature of not lower than 80° C. and an exothermic peak temperature of not higher than 150° C. in a DSC curve of the one-component type thermosetting resin composition as measured by a differential scanning calorimeter at a temperature increase rate of 10° C./min, and
the one-component type thermosetting resin composition satisfies at least one selected from the group consisting of the following items (1) to (3):
(1) the one-component type thermosetting resin composition further comprises, in an amount of 0.5 parts by mass to 15.0 parts by mass, a urea compound (E) represented by general formula (X):
R¹—NH—C(═O)—N—R²₂ (X)
where R¹ is a substituted or unsubstituted hydrocarbon group having 1 to 20 carbon atoms, and two R² are each independently a substituted or unsubstituted hydrocarbon group having 1 to 20 carbon atoms,
a ratio (Wc/We) of a total mass Wc of the dicyandiamide (C) to a total mass We of the urea compound (E) is 1.1 to 20.0, and
a ratio (We/Wd) of the total mass We of the urea compound (E) to a total mass Wd of the amine adduct curing agent (D) is 1.1 to 20.0;
(2) the one-component type thermosetting resin composition further comprises an epoxy-based reactive diluent (F) in an amount of 1.0 part by mass to 20.0 parts by mass; and
(3) the shell layer of the polymer particles (B) has an epoxy group, and a contained amount of the epoxy group in the shell layer with respect to a total mass of the shell layer is more than 0 mmol/g and not more than 2.0 mmol/g.

2. The one-component type thermosetting resin composition according to claim 1, wherein:
the one-component type thermosetting resin composition satisfies the item (1) and/or the item (2),
the shell layer of the polymer particles (B) has an epoxy group, and
a contained amount of the epoxy group in the shell layer with respect to a total mass of the shell layer is more than 0 mmol/g and not more than 2.0 mmol/g.

3. The one-component type thermosetting resin composition according to claim 1, wherein:
the one-component type thermosetting resin composition satisfies the item (1) and/or the item (2), and
the shell layer of the polymer particles (B) does not have an epoxy group.

4. The one-component type thermosetting resin composition according to claim 1, wherein the one-component type thermosetting resin composition satisfies the item (1), and further comprises the epoxy-based reactive diluent (F) in an amount of 1.0 part by mass to 20.0 parts by mass.

5. The one-component type thermosetting resin composition according to claim 1, wherein the core layer contains at least one type selected from the group consisting of diene-based rubbers, (meth)acrylate-based rubbers, and organosiloxane-based rubbers.

6. The one-component type thermosetting resin composition according to claim 1, wherein the shell layer contains a structural unit derived from at least one type of monomer selected from the group consisting of aromatic vinyl-based monomers, vinyl cyanide-based monomers, and (meth)acrylate-based monomers.

7. The one-component type thermosetting resin composition according to claim 1, wherein:
the one-component type thermosetting resin composition satisfies the item (2), and
the epoxy-based reactive diluent (F) contains an epoxy-based reactive diluent having one epoxy group in one molecule.

8. The one-component type thermosetting resin composition according to claim 1, wherein the amine adduct curing agent (D) contains an amine adduct curing agent having a softening temperature of 80° C. to 140° C.

9. The one-component type thermosetting resin composition according to claim 1, wherein:
the one-component type thermosetting resin composition satisfies the item (1), and
the urea compound (E) contains 3-(3,4-dichlorophenyl)-1,1-dimethylurea and/or 3,3′-[methylenebis(4,1-phenylene)]bis(1,1-dimethylurea).

10. A cured product obtained by curing the one-component type thermosetting resin composition according to claim 1.

11. An adhesive agent comprising the one-component type thermosetting resin composition according to claim 1.

12. A laminate comprising:
at least two base materials; and
an adhesive layer that is for bonding the at least two base materials, and that is obtained by curing the adhesive agent according to claim 11.

13. The laminate according to claim 12, wherein the at least two base materials are at least two base materials that have different linear expansion coefficients.

14. A method for producing the laminate according to claim 12, the method comprising a step of curing the adhesive agent under a curing temperature of 115° C. to 145° C., and a curing time of 10 minutes to 60 minutes.

15. A method for producing the one-component type thermosetting resin composition according to claim 1, the method comprising:
mixing all components of the one-component type thermosetting resin composition except for the amine adduct curing agent (D) to form a mixture, and
mixing the amine adduct curing agent (D) with the mixture.
